(19) United States
(12) Patent Application Publication
(10) Pub. No.: US 2010/0145865 A1
(43) Pub. Date: Jun. 10, 2010

(54) MANAGING AND SECURING CONSTRUCTION AND RENTAL EQUIPMENT

(76) Inventors: Thomas R. Berger, Cumming, GA (US); Joseph E. Denny, Atlanta, GA (US)

Correspondence Address: TILLMAN WRIGHT, PLLC, PO BOX 49309, CHARLOTTE, NC, 28277-0076, US

(21) Appl. No.: 12/609,008

(22) Filed: Oct. 29, 2009

Related U.S. Application Data
(63) Continuation-in-part of application No. PCT/US2009/044277, filed on May 16, 2009.
(60) Provisional application No. 61/109,496, filed on Oct. 29, 2008.
(60) Provisional application No. 61/053,665, filed on May 16, 2008.
(60) Provisional application No. 61/147,917, filed on Jan. 28, 2009.
(60) Provisional application No. 61/140,883, filed on Dec. 25, 2008.
(60) Provisional application No. 61/140,882, filed on Dec. 25, 2008.
(60) Provisional application No. 61/140,881, filed on Dec. 25, 2008.
(60) Provisional application No. 61/140,880, filed on Dec. 25, 2008.
(60) Provisional application No. 61/109,502, filed on Oct. 29, 2008.
(60) Provisional application No. 61/109,505, filed on Oct. 30, 2008.
(60) Provisional application No. 61/109,500, filed on Oct. 29, 2008.
(60) Provisional application No. 61/155,887, filed on Feb. 26, 2009.
(60) Provisional application No. 61/147,839, filed on Jan. 28, 2009.
(60) Provisional application No. 61/141,021, filed on Dec. 29, 2008.
(60) Provisional application No. 61/140,888, filed on Dec. 25, 2008.
(60) Provisional application No. 61/140,887, filed on Dec. 25, 2008.
(60) Provisional application No. 61/151,168, filed on Feb. 9, 2009.
(60) Provisional application No. 61/172,655, filed on Apr. 24, 2009.
(60) Provisional application No. 61/151,185, filed on Feb. 9, 2009.
(60) Provisional application No. 61/150,298, filed on Feb. 5, 2009.
(60) Provisional application No. 61/109,494, filed on Oct. 29, 2008.

(51) Int. Cl. G08B 13/14; G06Q 30/00; G06Q 50/00; G06Q 10/00

(52) U.S. Cl. 705/307; 340/572.1

(57) ABSTRACT

RSNs are attached to equipment at construction sites. Gateways located and construction sites. A rental company uses presence data to know in real-time which of multiple yards specific equipment is located for meeting customer needs. At a renter's construction site, a gateway receives engine-hours data from RSNs associated with rental equipment and reports to the rental company, which uses the data to determine whether contract limits on use are exceeded and/or whether the equipment is abused. For sites not having a gateway, a truck-mounted gateway is used to periodically visit and collect data from the RSNs at each site. The data collected is sent to the rental company via cellular link. A construction company uses the system to track and monitor its own equipment in storage yards and on construction sites. Classes are assigned such that a rental company sees only the rented equipment. RSNs send theft and vandalism alarms.

### CROSS-REFERENCE TO RELATED APPLICATIONS

The present application is a U.S. nonprovisional patent application of, and claims priority under 35 U.S.C. §119(e) to: U.S. provisional patent application No. 61/109,496, filed Oct. 29, 2008, titled “Systems and Apparatus for Managing and Securing Construction and Rental Equipment”, which is incorporated herein by reference. Furthermore, the present application is a continuation-in-part of, and claims priority under 35 U.S.C. §120 to, each of:
(1) International patent application no. PCT/US2009/044277, filed May 16, 2009 and designating the United States, titled “Securing, Monitoring and Tracking Shipping Containers”, which is incorporated herein by reference, and which '277 international application is a nonprovisional of and claims priority to each of,
   (a) U.S. provisional patent application 61/053,665, filed May 16, 2008, incorporated herein by reference;
   (b) U.S. provisional patent application 61/109,494, filed Oct. 29, 2008, incorporated herein by reference;
   (c) U.S. provisional patent application 61/151,168, filed Feb. 9, 2009, incorporated herein by reference;
   (d) U.S. provisional patent application 61/140,882, filed Dec. 25, 2008, incorporated herein by reference;
   (e) U.S. provisional patent application 61/140,887, filed Dec. 25, 2008, incorporated herein by reference;
   (f) U.S. provisional patent application 61/140,888, filed Dec. 25, 2008, incorporated herein by reference;
   (g) U.S. provisional patent application 61/141,021, filed Dec. 29, 2008, incorporated herein by reference;
   (h) U.S. provisional patent application 61/147,839, filed Jan. 28, 2009, incorporated herein by reference;
   (i) U.S. provisional patent application 61/147,917, filed Jan. 28, 2009, incorporated herein by reference; and
   (j) U.S. provisional patent application 61/155,887, filed Feb. 26, 2009, incorporated herein by reference; and
(2) U.S. nonprovisional patent application Ser. No. 12/607,040, filed Oct. 27, 2009, titled “Managing and Monitoring Emergency Services Sector Resources”, which is incorporated herein by reference, and which '040 application is a nonprovisional of and claims priority to each of,
   (a) U.S. provisional patent application 61/140,887, filed Dec. 25, 2008, incorporated herein by reference;
   (b) U.S. provisional patent application 61/109,500, filed Oct. 29, 2008, incorporated herein by reference;
   (c) U.S. provisional patent application 61/109,505, filed Oct. 30, 2008, incorporated herein by reference;
   (d) U.S. provisional patent application 61/109,502, filed Oct. 29, 2008, incorporated herein by reference;
   (e) U.S. provisional patent application 61/140,880, filed Dec. 25, 2008, incorporated herein by reference;
   (f) U.S. provisional patent application 61/140,881, filed Dec. 25, 2008, incorporated herein by reference;
   (g) U.S. provisional patent application 61/140,882, filed Dec. 25, 2008, incorporated herein by reference;
   (h) U.S. provisional patent application 61/140,883, filed Dec. 25, 2008, incorporated herein by reference;
   (i) U.S. provisional patent application 61/141,021, filed Dec. 29, 2008, incorporated herein by reference;
   (j) U.S. provisional patent application 61/147,917, filed Jan. 28, 2009, incorporated herein by reference;
   (k) U.S. provisional patent application 61/147,839, filed Jan. 28, 2009, incorporated herein by reference;
   (l) U.S. provisional patent application 61/150,298, filed Feb. 5, 2009, incorporated herein by reference;
   (m) U.S. provisional patent application 61/151,185, filed Feb. 9, 2009, incorporated herein by reference;
   (n) U.S. provisional patent application 61/155,887, filed Feb. 26, 2009, incorporated herein by reference;
   (o) U.S. provisional patent application 61/172,655, filed Apr. 24, 2009, incorporated herein by reference; and
   (p) U.S. provisional patent application 61/254,126, filed Oct. 22, 2009, incorporated herein by reference.

For ease of reference, the disclosure of Exhibit A of priority provisional application 61/109,496, which discloses an exemplary scenario regarding systems and apparatus for managing and securing construction and rental equipment, and the disclosure of Exhibit B of priority provisional application 61/109,496, which comprises a power point slide presentation regarding systems and apparatus for managing and securing construction and rental equipment, are respectively found included Appendices A and B attached hereto, which appendices are incorporated herein by reference.

Additionally, the present application hereby incorporates herein by reference each of the following identified U.S. patent applications—as well as any publications thereof and any patents issuing therefrom; the following identified U.S. patent application publications; and the following identified U.S. patent Ser. Nos. 12/468,047; 12/367,544 (US 2009-0135000 A1); Ser. No. 12/367,543 (US 2009-0161642 A1); Ser. No. 12/367,542 (US 2009-0181623 A1); Ser. No. 12/353,197 (US 2009-0129306 A1); Ser. No. 12/352,992 (US 2009-0122737 A1); Ser. No. 12/343,865 (US 2009-0104902 A1); Ser. No. 12/343,822 (US 2009-0103462 A1); Ser. No. 12/271,850 (US 2009-0092082 A1); Ser. No. 12/140,253 (US 2008-0303897 A1); Ser. No. 11/930,797 (US 2008-0151850 A1); Ser. No. 11/930,793 (US 2008-0112378 A1); Ser. No. 11/930,788 (US 2008-0165749 A1); Ser. No. 11/930,785 (US 2008-0143484 A1); Ser. No. 11/930,782 (US 2008-0212544 A1); Ser. No. 11/930,779 (US 2008-0129458 A1); Ser. No. 11/930,777 (US 2008-0111692 A1); Ser. No. 11/930,770 (US 2008-0144554 A1); Ser. No. 11/930,761 (US 2008-0112377 A1); Ser. No. 11/930,753 (US 2008-0142592 A1) now U.S. Pat. No. 7,535,339; Ser. No. 11/930,749 (US 2008-0130536 A1) now U.S. Pat. No. 7,538,658; Ser. No. 11/930,740 (US 2008-0150723 A1) now U.S. Pat. No. 7,538,657; Ser. No. 11/930,736 (US 2008-0143483 A1) now U.S. Pat. No. 7,538,656; Ser. No. 11/847,309 (US 2007-0291724 A1); Ser. No. 11/847,295 (US 2007-0291690 A1); Ser. No. 11/832,998 (US 2007-0273503 A1) now U.S. Pat. No. 7,378,959; Ser. No. 11/832,991 (US 2007-0268134 A1) now U.S. Pat. No. 7,378,958; Ser. No. 11/832,979 (US 2007-0268126 A1) now U.S. Pat. No. 7,378,957; Ser. No. 11/610,427 (US 2007-0159999 A1); Ser. No. 11/618,931 (US 2007-0155327 A1); Ser. No. 11/555,173 (US 2007-0099629 A1); Ser. No. 11/555,164 (US 2007-0099628 A1); Ser. No. 11/465,466 (US 2007-0043807 A1); Ser. No. 11/465,796 (US 2007-0041333 A1); Ser. No. 11/460,976 (US 2008-0315596 A1); Ser. No. 11/428,536 (US 2007-0002793 A1); Ser. No. 11/428,535 (US 2007-0002792 A1); Ser. No. 11/425,047 (US 2007-0069885 A1) now U.S. Pat. No. 7,554,442; Ser. No. 11/425,040 (US 2006-0287008 A1) now U.S. Pat. No. 7,539,520; Ser. No. 11/424,850 (US 2007-0004331 A1); Ser. No. 11/424,849 (US 2007-0004330 A1) now U.S. Pat. No. 7,574,168; Ser. No. 11/424,847 (US 2007-0001898 A1) now U.S. Pat. No. 7,583,769; Ser. No. 11/424,845 (US 2006-0287822 A1) now U.S. Pat. No. 7,574,300; Ser. No. 11/423,127 (US 2006-0289204 A1) now U.S. Pat. No. 7,563,991; Ser. No. 11/422,306 (US 2006-0282217 A1) now U.S. Pat. No. 7,542,849; Ser. No. 11/422,304 (US 2006-0276963 A1) now U.S. Pat. No. 7,526,381; Ser. No. 11/422,321 (US 2006-0276161 A1); Ser. No. 11/422,329 (US 2006-0274698 A1) now U.S. Pat. No. 7,529,547; Ser. No. 11/306,765 (US 2008-0136624 A1) now U.S. Pat. No. 7,394,361; Ser. No. 11/306,764 (US 2006-0237490 A1) now U.S. Pat. No. 7,391,321; Ser. No. 11/193,300 (US 2007-0024066 A1) now U.S. Pat. No. 7,438,334; Ser. No. 11/161,550 (US 2007-0002808 A1) now U.S. Pat. No. 7,430,437; Ser. No. 11/161,545 (US 2006-0018274 A1) now U.S. Pat. No. 7,221,668; Ser. No. 11/161,542 (US 2006-0023679 A1) now U.S. Pat. No. 7,522,568; Ser. No. 11/161,540 (US 2007-0004431 A1) now U.S. Pat. No. 7,200,132; Ser. No. 11/161,539 (US 2006-0023678 A1) now U.S. Pat. No. 7,209,468; Ser. No. 10/987,964 (US 2005-0093703 A1) now U.S. Pat. No. 7,155,264; Ser. No. 10/987,884 (US 2005-0093702 A1) now U.S. Pat. No. 7,133,704; Ser. No. 10/604,032 (US 2004-0082296 A1) now U.S. Pat. No. 6,934,540; Ser. No. 10/514,336 (US 2005-0215280 A1) now U.S. Pat. No. 7,209,771; and Ser. No. 09/681,282 (US 2002-0119770 A1) now U.S. Pat. No. 6,745,027.

Each of the foregoing patent application publications and patents is hereby incorporated herein by reference for purposes of disclosure herein of common designation (CD) technology (such as, e.g., class-based network (CBN) technology); wake-up (WU) technology; and networks that utilize such technologies (such as those of Terahop Networks, Inc. of Alpharetta, Ga.). It is intended that the CD/CBN and WU technologies, and related features, improvements, and enhancements—as disclosed in these incorporated references—may be utilized in combination with various embodiments and implementations of the present invention relating to equipment tracking and monitoring, especially rental construction equipment tacking and monitoring.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND TO THE PRESENT INVENTION

It is believed that traditional construction equipment wireless asset-management solutions typically utilize some form of RFID and/or GPS technology. Both of these technologies have limitations.

The most common form of RFID is passive RFID. Passive RFID systems require a substantial infrastructure as the limited range of the tags requires many “check points” in order for them to be read. For a tag to be read, either it (and the equipment to which it is attached) has to pass close to a reader, or a reader must be brought close to the tag. Consequently, much infrastructure is required, which is usually cost-prohibitive, and it can be inconvenient and disruptive to get tags and readers close. Also, depending on the site itself, the structures and AC power to support the infrastructure may not be readily available, which may be a major consideration, such as at a new construction site.

In addition, RFID tags typically have little or no memory; so, unless a tag is in proximity of a reader at the time of an event, an event may not be recorded and may go unrecognized. RFID-based systems may lack the ability to interface with external sensors, such as engine run-time monitors. Lastly, as a construction site changes (as structures are erected or demolished), the network infrastructure for RFID may need to be continually re-configured and tested to assure adequate and complete coverage.

Another form of RFID is active RFID. The tags used in active RFID systems have an extended coverage range, which helps resolve some of the proximity and infrastructure issues. However, many of the other limitations in traditional use of RFID tags, such as power requirements, memory, infrastructure installation fussiness, and external sensor interfaces, are not well addressed with this technology.

Thus, with respect to traditional wireless asset-management solutions utilizing RFID tags, events must take place near a sensor reader in order to be reported at the time and location they take place; the limited range of sensors requires more infrastructure to get sufficient sensor coverage; it can be time consuming and expensive to set-up, configure, and maintain the network infrastructure; and on-board sensor memory is usually not available to capture all event data, even events that occur after hours, including weekends and on holidays.

In contrast to the foregoing, GPS technology requires no local infrastructure and provides accurate location capability; however, the GPS devices and associated data-link services needed to make full use of this technology can be costly. Specifically, there must be a separate data link available to communicate the GPS-derived location of the equipment to a user application. Otherwise, the equipment “knows” where it is, but the equipment manager does not. Those data links can be expensive.

GPS technology has a high power drain, requiring the devices to be mounted on or near a permanent power source or it requires the frequent change-out of batteries, increasing the system maintenance requirements and potentially reducing the system's reliability. Also, the devices used for GPS are somewhat bulky and are usually mounted in an exposed area for adequate satellite line-of-site. This makes the devices susceptible to frequent damage and/or to deliberate disablement by thieves.

GPS technology is most effective with a clear line-of-site to satellites and, therefore, is not effective for equipment that may be located in storage facilities or hindered by other site structures. Lastly, due to the complexity of the technology, installation of the GPS devices can be intricate, increasing system installation costs.

GPS-based systems, as well as other locating technologies such as LoJack, are often also limited to tracking an asset only after the absence has been noticed and recorded. Since thieves know this, thefts usually occur over weekends, giving the thieves as much as 60 hours to escape before the theft is discovered on Monday morning.

Thus, with respect to traditional wireless asset-management solutions utilizing GPS technology, GPS devices mounted to the monitored assets require a clear line-of-site to satellites, which limits their operating area; GPS systems can be effective in finding assets after they have been stolen but do little to initiate alarms or notify authorities at the time the theft is taking place; GPS devices have a high current drain requiring a constant power supply or frequent change-out of batteries; the large size and exposed mounting makes the hardware susceptible to frequent damage and/or disablement; data links for GPS back-haul communications can be expensive; and GPS devices themselves can be expensive.

In contrast to the foregoing traditional wireless asset-management solutions, recent advances in ad hoc networking as applied to asset tracking have occurred, as represented by the CBN and WU technologies of the incorporated patents and published patent applications, whereby the tracking of large numbers (i.e., thousands) of movable/moving assets via the monitoring of sensors attached thereto can be accomplished in a practical and commercially viable manner.

One or more preferred embodiments of the present invention address the aforementioned shortcomings of the more traditional RFID and GPS systems while extending the recent technological advances represented by the CBN and WU technologies in still yet further inventive ways.

### SUMMARY OF THE INVENTION

The present invention generally relates to networks, apparatus, methods, and systems for monitoring and managing resources, and facilitating such monitoring and management.

The present invention includes many aspects and features. Moreover, while many aspects and features relate to, and arc described in, the context of managing and securing construction equipment—including rental construction equipment, the present invention is not limited to use only in managing and securing construction and rental equipment. For example, preferred embodiments of the present invention may be used in managing resources and equipment by FEMA.

In an aspect of the invention, a system in which construction equipment is tracked and monitored includes: items of construction equipment, each item including a remote sensor node (RSN) associated therewith, each RSN including one or more class designations; and a gateway controller, the gateway controller sharing at least one class designation in common with each RSN such that each RSN is able to communicate, directly or indirectly, with the gateway over a class-based network, the gateway controller configured to electronically communicate data from each RSNs for receipt by software running on a server that monitors and tracks the items of construction equipment associated with the RSNs from which the data is received.

In a feature, the system further includes a message management and routing system that facilitates communication between the gateway controller and the software running on the server. The message management and routing system may be configured to handle requests for, and establish connections between, the gateway controller and the software running on the server.

In a feature, the gateway controller is fixedly located at a site at which the items of construction equipment are located.

In a feature, the gateway controller is configured to electronically communicate data from the RSNs over a wide area network (WAN). The gateway controller may communicate data from the RSNs over a wired broadband connection.

In a feature, the gateway controller is mobile and is intermittently located at a site at which at least some of the items of construction equipment are located, other times being away from said site. The gateway controller may be attached to a motor vehicle, and wherein the gateway controller communicates with the RSNs when driven within proximity of a site at which at least some of the items of construction equipment are located. Additionally, the gateway controller may communicates data from the RSNs over a cellular network, over a satellite network, over a WiMAX network, a wireless broadband connection, or combination thereof.

In a feature, each of the RSNs associated with the items of construction equipment are configured to send alerts indicative of theft of the items of construction.

In a feature, each of the RSN includes one or more sensors associated therewith.

In a feature, one of the sensors is meter that measures the time of operation of an item of construction equipment.

In a feature, the data communicated from one of the RSNs includes data regarding how long one of the items of the construction equipment associated with the particular one of the RSNs was operated.

In a feature, the data communicated from one of the RSNs includes runtime data pertaining to one of the items of the construction equipment associated with the particular one of the RSNs.

In a feature, the data comprises engine-hours data.

In a feature, at least one of the items of construction equipment is rented from a rental company.

In a feature, the items of construction equipment are rented from a rental company. The server running the software may owned by the rental company. Additionally, the data communicated from one of the RSNs may include presence data pertaining to the continued presence of each of the items of the construction equipment associated with the particular RSNs, whereby the rental company determines whether any of the items of the rental equipment have been removed from one or more sites at which the items of construction equipment are located; and the data communicated from one of the RSNs may include runtime data pertaining to one of the items of the construction equipment associated with the particular one of the RSNs, whereby the rental company determines whether contract limits on use of the rental equipment have been exceeded.

In a feature, at least one of the items of construction equipment is rented from a rental company, wherein the server running the software is owned by the rental company, and further comprising a plurality of additional RSNs configured to monitor for intrusions onto a site at which at least some of the items of construction equipment are located, the gateway controller sharing at least one class designation in common with each additional RSN such that each additional RSN is able to communicate, directly or indirectly, with the gateway over a different class-based network, the gateway controller configured to electronically communicate data sent from each of the additional RSNs for receipt by different software running on a different server that monitors the security of the site. The different software running on a different server that monitors the security of the site may be owned by a security monitoring company and not by the rental company. Furthermore, none of the RSNs associated with the items of construction equipment that are rented from the rental company may share a class in common with any of the additional RSNs, whereby distinct and separate radio networks are formed at the site.

Other aspects of the invention includes the methods utilized in the foregoing system.

In addition to any aspects and features of the present invention mentioned above and below, the present invention further encompasses the various possible combinations and subcombinations of such aspects and features.

Finally, it is explicitly contemplated that systems, networks, and apparatus of the present invention may employ and utilize, and do employ and utilize, each and any of the inventive aspects and features of the incorporated references including, by way of example, and not limitation: the inventive aspects and features of incorporated U.S. patent application publication titled “Class Switched Networks for Tracking Articles”; the inventive aspects and features of incorporated U.S. patent application publication titled “Systems and Methods Having LPRF Device Wake Up Using Wireless Tag”; the inventive aspects and features of incorporated U.S. patent application publication titled “Forming Communication Cluster of Wireless Ad Hoc Network Based on Common Designation”; the inventive aspects and features of incorporated U.S. patent application publication titled “Forming Ad Hoc RSI Networks Among Transceivers Sharing Common Designation”; the inventive aspects and features of incorporated U.S. patent application publication titled “Communications Within Population of Wireless Transceivers Based On Common Designation”; the inventive aspects and features of incorporated U.S. patent application publication titled “Transmitting Sensor-Acquired Data Using Step-Power Filtering”; the inventive aspects and features of incorporated U.S. patent application publication titled “Network Formation in Asset-Tracking System Based on Asset Class”; the inventive aspects and features of incorporated U.S. patent application publication titled “LPRF Device Wake Up Using Wireless Tag”; the inventive aspects and features of incorporated U.S. patent application publication titled “Propagating Ad Hoc Wireless Networks Based on Common Designation and Routine”; the inventive aspects and features of incorporated U.S. patent application publication titled “Remote Sensor Interface (RSI) Stepped Wake-Up Sequence”; the inventive aspects and features of incorporated U.S. patent application publication titled “All Weather Housing Assembly for Electronic Components”; the inventive aspects and features of incorporated U.S. patent application publication titled “Operating GPS Receivers in GPS-Adverse Environment”; the inventive aspects and features of incorporated U.S. patent application publication titled “Remote Sensor Interface (RSI) Having Power Conservative Transceiver for Transmitting and Receiving Wakeup Signals”; the inventive aspects and features of incorporated U.S. patent application publication titled “Event-Driven Mobile HAZMAT Monitoring”; the inventive aspects and features of incorporated U.S. patent application publication titled “Communicating via Nondeterministic and Deterministic Network Routing”; the inventive aspects and features of incorporated U.S. patent application publication titled “Maintaining Information Facilitating Deterministic Network Routing”; the inventive aspects and features of incorporated U.S. patent application publication titled “Determining Relative Elevation Using GPS and Ranging”; the inventive aspects and features of incorporated U.S. patent application publication titled “Using GPS and Ranging to Determine Relative Elevation of an Asset”; the inventive aspects and features of incorporated U.S. patent application publication titled “Determining Presence of Radio Frequency Communication Device”; and the inventive aspects and features of incorporated U.S. patent application publications titled “Communications and Systems Utilizing Common Designation Networking”.

Thus, for instance, it is within the scope of the disclosed invention that implementations in accordance with at least some preferred embodiments of the invention utilize one or more aspects and features set forth and identified in the incorporated U.S. patent application publication titled “Communicating via Nondeterministic and Deterministic Network Routing”. Indeed, utilization of this technology in the construction equipment context enables significant advances and benefits in such context when extended in accordance with the present invention. In particular, by including node pathways in inbound messages to a gateway controller or server, as set forth in the incorporated U.S. patent application publication titled “Communicating via Nondeterministic and Deterministic Network Routing”, the gateway controller or server can derive therefrom knowledge of the presence of the nodes by which the message was delivered. Sending back along the deterministic pathway an ACK then may signify to each intermediate node passing the message that the gateway controller or server has identified the presence of such node. Such node then may “reset” its protocol for responding to, for instance, a Presence Broadcast (as defined and used in the incorporated U.S. patent application publication titled “Determining Presence of Radio Frequency Communication Device”); or such node may reset a timer by which the node is configured to send a presence message to the gateway controller or server at predetermined time intervals. It is believed that, by leveraging hopping in this manner, the number of responses to Present Broadcasts and the number of messages sent to indicate presence of a node, can be significantly reduced.

The long battery life and the long range communication capabilities resulting from hopping provided by the utilization of CBN and WU technologies makes true monitoring and tracking of mobile and/or movable assets practical and commercially viable. This practicality and viability opens up many inventive implementations having commercial benefits, the desires for which have long been felt, but the means for which have heretofore been unobtainable. A detailed description such an inventive implementation in the context of construction equipment monitoring and tracking is now set forth.

### BRIEF DESCRIPTION OF THE DRAWINGS

One or more preferred embodiments of the present invention now will be described in detail with reference to the accompanying drawings, wherein the same elements are referred to with the same reference numerals, and wherein:

FIG. 1 illustrates a system used to managed and secure construction equipment in accordance with one or more preferred embodiments of the present invention;

FIG. 2 illustrates a system in accordance with one or more preferred embodiments provided by a managing entity (e.g., a commercial service provider) wherein a plurality of discrete wireless islands are linked, through a common message handling component named an MMR, and are capable of presenting common access and views to multiple customers of the managing entity regarding assets to which the RSNs are attached;

FIG. 3 illustrates latency requirements of each corresponding logical subsystem, which generally corresponds to the vertical ordering of the blocks shown in FIG. 2, and additionally illustrates the flow of data between a wireless island—in this example a radio network—and a customer application host, all in accordance with one or more preferred embodiments of the invention;

FIG. 4 illustrates that, in order to enable communication between a radio network and a customer application, the MMR component routes addresses to both a gateway controller of the radio network and an EGW associated with the customer application, at which point communications between the radio network and the user application will follow the primary data path shown, all in accordance with one or more preferred embodiments of the invention;

FIG. 5 is a model illustrating logical subsystems of an exemplary MMR component in accordance with a preferred embodiment of the invention;

FIG. 6 is a reference model illustrating in more detail the logical subsystems of the MMR component of FIG. 5;

FIG. 7 illustrates a system used to managed and secure construction equipment in accordance with a preferred embodiment of the present invention;

FIG. 8 illustrates additional portions of the system for managing and securing construction equipment of FIG. 7;

FIG. 9 illustrates a system used to managed and secure construction equipment at multiple sites in accordance with a preferred embodiment of the present invention; and

FIG. 10 illustrates a gateway router used in conjunction with a gateway controller for expanding the area coverage for radio networks at a site.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Additionally, a “radio network” in accordance with one or more preferred embodiments disclosed herein preferably comprises a gateway server, one or more gateways (sometimes termed gateway routers), and a plurality of remote sensor nodes or “RSNs”. Each RSN preferably includes CBN and WU technologies as previously mentioned. Each gateway is preferably connected to the gateway server, which comprises software and a computing device on which that software runs. A gateway that is connected to a gateway server is described as “captured”, while a gateway that is not connected to a gateway server is described as “free”. Similarly, an RSN that is connected to a radio network is described as “captured”, while an RSN that is not connected to a radio network is described as “free”.

When an RSN is captured by a radio network, the RSN can be characterized as a “node” of the radio network and can function as both an end point as well as a routing device for messages passed through the network. Further, each gateway may include one or more “gateway RSNs” or “top level RSNs”, each of which functions as a communication interface with the gateway for other RSNs. Thus, in a radio network, each gateway, just like each RSN, can be characterized as a “node” of a radio network, depending on the context of use.

A gateway and gateway server together collectively comprise a “gateway controller” (GC). Such a gateway controller can switch between functioning solely as a gateway, and functioning as a gateway controller. A gateway and gateway server that are integrated together can be characterized as an “integrated” gateway controller, while a gateway and gateway server that are physically separate, and preferably connected by a high-capacity, high-reliability data link, can be characterized as a “logical” gateway controller.

### Construction Equipment Implementation

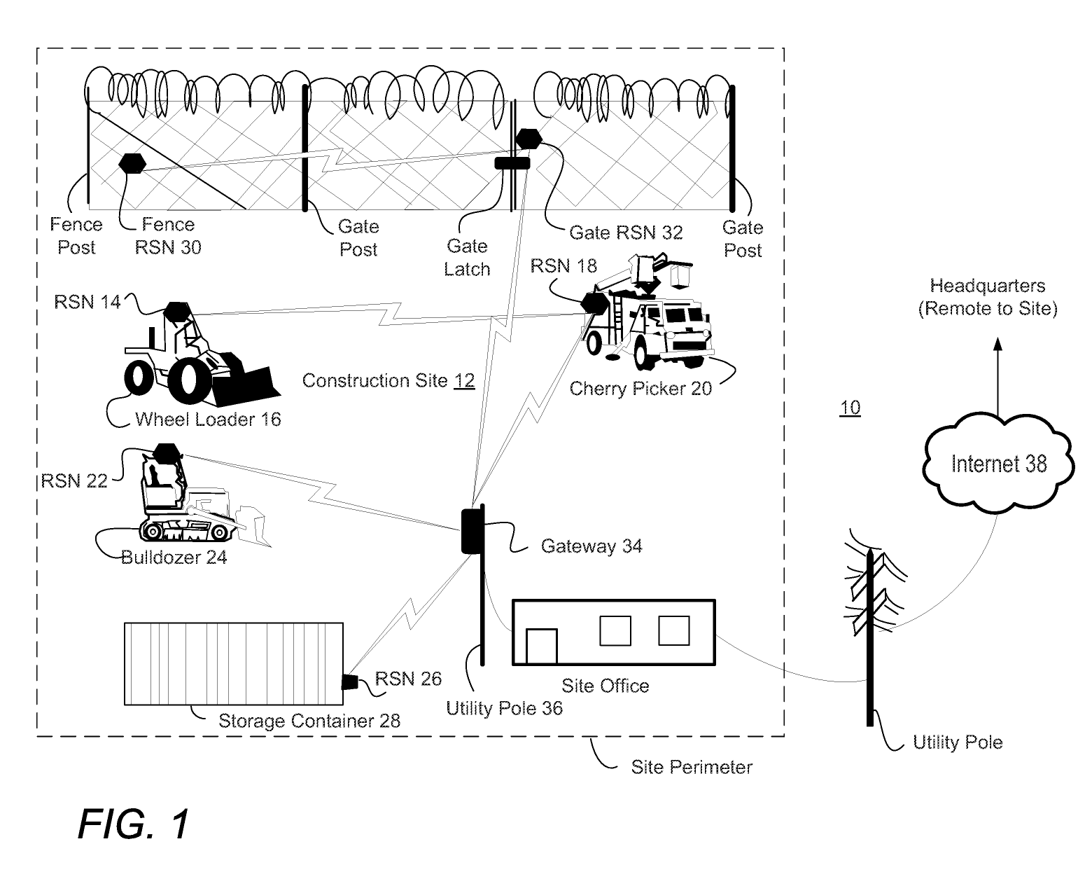

FIG. 1 illustrates a system 10 used to managed and secure construction equipment at a construction site 12 in accordance with a preferred embodiment of the present invention. The system generally includes the following components: remote sensor nodes or “RSNs” located onsite; one or more gateways; an external network comprising a Wide Area Network or “WAN”, preferably comprising the Internet; and one or more asset management software applications for tracking and monitoring assets running on one or more servers. An RSN is attached to each piece of equipment that is monitored, and the RSNs form radio networks with one or more gateways whereby communications over the Internet are enabled between the RSNs and the one or more asset management software applications.

Moreover, it should be noted that, if and when used herein, a “public” radio network as used herein is owned and operated by the managing entity and is configured to allow RSNs associated with any customer of the managing entity to connect to it. A “shared” radio network is similar to a public radio network in that it is configured to allow RSNs associated with any customer to connect to it, but it is not owned by the managing entity; instead, it is owned typically by the parties sharing the gateway controller that manages the shared public radio. A “private” radio network is owned by a customer and is configured to allow only RSNs associated with that customer, or otherwise specified as allowed, to connect to it.

Each of the components of the preferred system 10 is now discussed in turn.

### Remote Sensor Nodes (RSNs)

The system 10 illustrated in FIG. 1 includes four RSNs attached to assets at the construction site 12 that are tracked and monitored. These four RSNs include: RSN 14 attached to wheel loader 16; RSN 18 attached to cherry picker 20; RSN 22 attached to bulldozer 24; and RSN 26 attached to storage container 28. The system 10 further includes RSNs attached to a perimeter fence that extends around the construction site 12, with RSN 30 being shown as representative of the fence RSNs; and an RSN 32 attached to a gate of the perimeter fence. These RSNs are used not to track or monitor assets, but instead to monitor and report any disturbances or breaches that might be indicative of theft or vandalism.

Each of these RSNs function as nodes in one or more wireless radio networks that form at the construction site, and each RSN includes a low power radiofrequency (LPRF) data communication device including therein a radio, a controller, and memory.

The radio preferably is a standards based radio, such as a Bluetooth radio. The Bluetooth radio preferably is configured in accordance with IEEE 802.15, together with one or more appropriate internal antennas.

The controller may include a microcontroller or microprocessor, integrated circuitry (IC), application specific integrated circuit (ASIC), or any combination thereof. The controller preferably is programmable and is configured to execute machine-executable instructions stored in the machine-readable medium comprising the memory. Preferably, the memory is sufficient to store operational software and at least 64 KB of sensor-derive data. Moreover, the RSN preferably is configured to allow updating and upgrading of both its onboard software and its onboard firmware. This can be accomplished either via a wireless link or by a physical connection to a suitable configuration device. Notably, any messages queued at the RSN must be transferred to a gateway router or gateway controller, or storage device, and such transfer acknowledged, prior to processing of an update or upgrade at an RSN.

Each RSN also preferably includes an internal clock or other chronometric component for keeping time and measuring time intervals.

Of course, each RSN also includes an internal power source, such as a battery, and may be configured to attach to an external power source, if applicable. For example, if an RSN is attached to an asset that includes a power source, such as the illustrated wheel loader, cherry picker, or bulldozer, then the RSN preferably draws power from such power source external to the RSN.

Each RSN further preferably includes a reduced complexity radio (RCR) for utilizing the WU technologies of the above-incorporated patent publications and patents, and each RSN also preferably utilizes CBN technologies of the above-incorporated patent publications and patents in forming radio networks and participating in network communications. Moreover, wake-up in accordance with the WU technologies preferably is class based. The RSN also preferably is not limited to membership in a single class: the RSN preferably is configured for assignment of multiple, concurrently active classes and, thus, for example, the RSN may be configured to respond to wake-up messages, and engagement in radio networks corresponding to, different classes. In this regard, the RSN preferably is capable of maintaining up to 16 concurrently active class memberships.

Indeed, it will be appreciated that RSNs normally are set to respond to or talk with only their own classes of RSNs. Consequently, commands sent to one class of RSNs (e.g., “All Heavy Duty Rental equipment, check in” sent to class “HeavyDutyRentals”) will elicit a response from only that class (i.e., only the RSNs assigned to Heavy Duty Rental), which will respond with, “present.” Similarly, a command can be sent to all RSNs at the site (a super-class of which all RSNs are members), with a gateway noting those RSNs responding back. RSNs that fail to respond back are flagged, and positive verification measures may be taken (e.g., someone is sent to the site) to check on their continued presence at the site. However, to affect maximum range and assure delivery of critical messages, RSNs may be commanded to respond to requests for message-relays from RSNs and gateways if a special class or super-class representing such critical messaging is used. Thus, since RSNs respond to only their classes, multiple companies or and discrete networks can operate in close or overlapping proximity without interference, and battery life of the RSNs is extended.

Preferably, both the Bluetooth radio and RCR of an RSN have a communications range using one or more internal antennas of the RSN of at least three hundred feet in the most challenging RF environment contemplated for the target applications. Similarly, both the Bluetooth radio and RCR preferably enjoy an open-space, line-of-sight range of at least eight hundred feet.

Each RSN further includes a unique identifier (UID) that preferably is encoded into firmware of the RSN at time of its manufacturer. UIDs are unique, i.e., are not duplicated, in that no two RSNs should have the same UID. Preferably, a numbering system used for the UID accommodates at least ten billion unique IDs. The combined use of CBNs and UIDs enables sharing of network infrastructure among many different users or entities.

The RSN is configured to receive commands from a gateway that sets frequencies on which the radios, i.e., the RCR and Bluetooth radio, operate.

Each RSN further is configured to “hop” messages in order for the message to reach a gateway. The RSN includes hopping algorithms and rules such that up to sixteen hops preferably can be made, using appropriate classes, i.e., up to fifteen RSN-to-RSN hops and then one RSN-to-gateway hop. The RSN also is configured to learn and store hop-path information, which helps minimize network latency and battery consumption. Moreover, each RSN is configured to enable or disable hopping. In this respect, it is desirable for an RSN to disable hopping, for example, when the battery of the RSN is low in order to preserve battery power for critical communications by the RSN. Furthermore, a hopping path chosen to forward data is determined at the moment of need, based on what worked in the past, revised by what is learned during the current attempt. Continual network-formation messaging is not used, and the spread of hopping attempts throughout the network is limited.

A message is shown as being hopped in FIG. 1, wherein RSN 14 communicates with RSN 18, with RSN 18 communicating with gateway controller 34. Similarly, fence RSN 30 communicates with gate RSN 32, with RSN 32 communicating with gateway controller 34.

Preferably, an internal battery has sufficient capacity to operate the RSN at full capability preferably for a period of at least two years, assuming at least 10,000 message events per year, per the environmental profile and space/weight constraints described herein. Each message event is assumed to include a wake-up/find-path transmission, a path-found receipt, a data transmission, and an acknowledgment data receipt. This requirement is exclusive of powering external sensors. The battery has a manufacturer code and date printed on its exterior. In preferred commercial implementations, the battery is preferably not user replaceable, but is implemented to facilitate replacement at a factory or service-center, preferably without soldering.

The RSN also is configured to monitor and report a battery level of the internal battery, both on-demand, i.e., upon a query from a configuration tool or an appropriate user application, and automatically per fixed threshold settings. There preferably are two thresholds that trigger such automatic reporting. A low battery alert threshold corresponds to approximately thirty days of useful battery life, assuming average usage, and a critical low battery alert corresponds to approximately ten days of useful battery life, assuming average usage. When each threshold is reached, a message is sent to a user application providing an alert that a low-battery condition exists for that RSN. The reporting preferably merely indicates either a “Low Battery Alert” or a “Critical Low Battery Alert”. Additionally, battery level reporting is capable of being used to transition, either automatically or by a user via a configuration tool or user application in response to a report, the RSN into a state where it no longer facilitates hopping for other RSNs, thus conserving its remaining battery life.

If desired, the RSN may be configured to suspend messaging in the event of a mass event, such as, for example, an earthquake, high winds, a storm, etc., until the mass event is over so as to prevent excess battery drain and network congestion caused by events that affect large numbers of RSNs in a given area simultaneously. This functionality is preferably implemented via logic, i.e., programming, at the RSN. Alternatively, the RSN is configured to receive instructions from a gateway router or gateway controller indicating either the occurrence of such a mass event or that the RSN should suspend messaging.

It will further be appreciated that the RSN may be in range of more than one gateway router or gateway controller. Preferably, the RSN includes preferential registration functionality which allows one or more gateways to be indicated as preferred, and ranked in order of preference, whereby the RSN registers and communicates only with the most preferred gateway.

Each RSN is accurately termed a remote sensor node in that each RSN preferably is associated with one or more sensors, whether external or internal. In this respect, it will be appreciated that RSNs each need not include all of the same sensors and the sensors associated with a particular RSN will depend on the use or intended use of such RSN. Accordingly, depending upon the use of the RSN, the RSN may be capable of detecting motion, vibration, and shock, and sensing whether motion, vibration, or shock exceeds certain preset conditions, using an appropriate sensor. An RSN further, depending upon the use of the RSN, may be capable of determining whether a door or gate has been open using an appropriate sensor. With other appropriate sensors, RSNs may be capable of detecting, for example, temperature and other weather conditions, and determining geographic position (e.g., GPS data using a GPS receiver). An RSN also may be capable of reading one or more RFID devices or tags within its proximity if configured with an appropriate reader and protocols for doing so.

With respect to external sensors associated with an RSN, an RSN may communicate with any such external sensors by wired connection directly to the RSN or by a wireless connection. Indeed, external sensors mounted anywhere within the communication range of the RSN may be associated with that RSN.

Each RSN is capable of storing/recording/buffering sensor-derived data and communicating such data over a radio network to one or more asset management applications. Moreover, using the chronometric component, each RSN preferably appends date/time stamps to such recorded data and appends a date/time stamp to its network communications. Preferably, time is reported or recorded for use by applications utilizing 24-hour GMT, plus a local-time offset indicator, and all time stamps preferably include this format.

The RSN is capable of being assigned user application-level behavioral states, such as, for example, via a gateway, and these states affect how the RSN behaves, e.g., with respect to subsequent inputs. For example, if the RSN is attached to an asset that is not scheduled to move, then the RSN is sent a message that changes the RSN's behavioral state such that it reports movement. Alternatively, if the RSN is attached to an asset that is expected to move within a particular period of time, then the RSN is sent a message that changes the RSN's behavioral state such that it reports if movement does not occur within such period of time. The RSN is also capable of self-assuming such states, based on known or sensed conditions such as, for example, time of day and day of week.

Preferably, the RSN includes its own housing. The housing is in the shape of a chamfered, elongated, and compressed box which is slightly rounded at its ends, and is bilaterally symmetrical along all 3 axes. The housing does not exceed an envelope having dimensions of three and a half inches by two and a half inches by one and a half inches. The housing preferably comprises molded plastic. A bottom of the housing is preferably flat over at least 75% of its surface, to facilitate attachment to flat surfaces. The housing preferably includes a quality-forensics code, e.g., a date code, molded into an interior surface. The housing further preferably includes one or more external labels, one of which preferably includes the UID of the RSN and a barcode corresponding to the UID.

Whether housed in a seal housing, or in its own housing, the RSN preferably includes one or more physical/electrical interfaces, and the respective housing is preferably configured to provide access to such interfaces, although at least some RSNs may not include interfaces or may not provide access to such interfaces.

Each interface includes some form of physical protection to prevent inadvertent metal-to-metal contact across connector pins when the interface is not engaged, i.e., in use. Each interface preferably also includes a means to minimize the probability of electrostatic discharge (ESD) damage, and to thwart reverse-polarity connections. The housing preferably includes covers and other interface-access features configured for manipulation by qualified service technicians in a service-depot environment. Such covers and features are configured to minimize the probability of inadvertent opening, deliberate tampering, and incorrect re-installation.

The interfaces are configured for connection to “sleds”, which are separate components configured for attachment to the RSN which expand the functionality of the RSN. Further, preferably, the interfaces provide connectivity to at least one TTL-level serial port. Preferably, sleds are configured to mate smoothly, electrically and physically, with the bottom of the RSN, with no gaps between the mating surfaces of the respective housings. The sleds themselves may be mounted or attached to construction equipment such as, for example, cranes, bulldozers, wheel loaders, cherry pickers, storage containers, and the like. Upon connection to a sled, or other external device, the RSN preferably does not reset any data, configuration, or state, and does not make attempt to transmit or transfer data, unless configured or commanded to do so. A sled is preferably attached in such a manner as to resist accidental detachment due to shock or vibration, and as to resist casual tampering, such as, for example, using Torx screws.

RSNs attached to an external sled also preferably include a motion detector and preferably interfaces with external sensors, such as an equipment engine run-time meter. In such cases, the RSN memory preferably is used to store profile data about the equipment the RSN is assigned to, such as: type, classification, year, make, model, etc. of the particular equipment.

Exemplary sleds include: a GPS sled; an external battery sled, which preferably includes circuitry configured to avoid conflicts with the internal battery; and external low-power sensor sleds. These low-power sensors are configured to be attached to, and read by, the RSN without the need for an additional battery, and preferably do not cause more than a 10% impairment in the battery life of the RSN.

The RSN is configured to store event data of defined events and activities in its memory. Defined events include, for example: the commencement of motion per a set threshold; a shock that exceeds a set threshold; a low battery warning; a critical low battery warning; and sled sensor events. The RSN also is capable of timing the duration of activities, and of timing intervals between events, as desired. Moreover, event data preferably includes an event-type identifier and a date/time stamp. The RSN is capable of transmitting raw event data to a gateway, but the RSN preferably includes sufficient memory capacity to store at least thirty event records. When storage capacity of the RSN is exceeded, older events are overwritten by newer events in a first-in-first-out manner.

In some preferred embodiments, RSNs arc configured to send quasi-periodical check-in messages indicating to the network that the RSN is still present (i.e., in the RF-vicinity of the gateway with which it is registered). The asset management application is configured to expect such messages, and if a predefined number of these messages are not received within a predefined period, then the RSN is considered to be no longer present and thus missing.

Additionally, in some preferred embodiments, a timer used to determine when to send these messages can be reset as a result of various communication activities of the RSN. In this respect, when an RSN passes a communication from another RSN along within the radio network that is intended for a gateway, information is also passed along with the message that reveals that the RSN was involved in the hopping as an intermediate node. Upon an acknowledge being passed back along the same path in the reverse order, the RSN deems that its continued presence has been detected. Thus, by passing a communication on along a path that eventually leads to the gateway with which the RSN is supposed to periodically check in, the RSN has essentially informed the gateway that it is still present. Consequently, the RSN resets its check-in timer, as there is no need to send a check-in message when the gateway is already aware that the RSN is still there. This methodology helps to reduce radio activity while still allowing for monitoring of RSN presence.

### Gateways

The system 10 illustrated in FIG. 1 includes a gateway controller (GC) 34 shown attached to a utility pole 36 from which the GC 34 draws its power. While only the GC 34 is shown, it will be understood that the construction site 12 may include a plurality of gateway routers, and it will be understood that GC 34 illustrated in FIG. 1 is further representative of such possible additional gateways routers at the construction site 12.

The GC 34 generally provides for communications with RSNs and provides local network control and management, event data storage, and management of communications with the external network, illustrated as comprising the Internet 38.

Preferred elements and functionality of the GC 34 will now be described and, where possible, functionality and elements will be described in a manner generic to both integrated gateway controller implementations and logical gateway controller implementations. It will be appreciated that, to the extent practicable, and generally unless otherwise noted, the elements and functionality described arc contemplated for use in both types of implementations. It will further be appreciated that although described as including various elements and functionality, in alternative embodiments and implementations, a gateway controller might reasonably be practiced in the absence of one or more of these elements or functionality.

The GC 34 includes one or more onboard controllers, i.e., processors, that manage the radios, messaging, memory, state-changes, power consumption, IO functionality, and applications of the GC 34, and that control all other gateway controller functions as described elsewhere herein. The processor is selected and configured such that its power and speed are sufficient to support all on-board applications at their normal performance levels.

The GC 34 further includes non-volatile memory, i.e., computer-readable storage, such as, for example, a hard drive, sufficient to store a plurality of event data records (“EDRs”), and other network management/control records, and to support network server functions, as described herein. The memory is partitionable as needed to provide the functionality described herein. This memory is preferably a part of gateway server hardware. Additionally, the GC 34 is preferably implemented using Linux.

Furthermore, Each EDR preferably includes a time/date-stamp regarding the occurrence of some event related to the system and its operation, or of the of absence/failure of an expected event. EDRs record the nature of the event, what element of the system was affected, and when the event occurred (time & date). EDRs may be temporarily stored on gateways as generated until uploaded as a batch file to a central data archive server.

The GC 34 includes whatever BIOS, operating system, protocol converters, generic APIs, or other software or firmware are required to establish basic functionality, enable further programming, and support functionality described herein.

The GC 34 is configured to readily accept loading and use of APIs for user interfaces or applications. For example, it is anticipated that multiple logical connections might be required for event data records, a bi-directional API, and an interface for RSN routing and authentication. Further, different message types will sometimes require different routing and handling. Message types include, for example, event data record messages and API messages.

Multiple logical connections are also contemplated for use for a Simple Network Management Protocol (SNMP) manager for RSNs, and an SNMP agent for internal gateway controller function monitoring and control.

The GC 34 is configured such that the version of any and all software, firmware, and hardware of the GC 34 is readable via a configuration tool, the message management and routing (MMR) system (as described elsewhere herein), and appropriate user applications.

The GC 34 is configured such that its onboard software and firmware can be updated or upgraded through any available communications link supported by the GC 34. In at least some implementations, the GC 34 can be upgraded or updated by physical connection to a suitable configuration device. Notably, no queued messages are lost due to such an update or upgrade, and no user-desirable stored data is erased or disrupted.

The timing of updates and upgrades is preferably selected or controlled by the owner of the GC 34, so as to afford the owner the opportunity to minimize disruption of the owner's intra-network and inter-network message traffic. Notably, however, neither updating nor upgrading takes the GC 34 out of service, except in that a reboot might be required to implement some changes. In at least some implementations, updates or upgrades can effect changes to one or more profiles of the GC 34.

The GC 34 includes a unique ID (UID) encoded into firmware at the manufacturer. UIDs are unique, i.e., are not duplicated, in that no two RSNs have the same UID. The numbering system used for the UID accommodates at least ten billion (i.e., 10̂9, or 10,000,000,000) unique IDs.

The GC 34 includes space in non-volatile memory for storing a unique Area ID, as described hereinabove. This Area ID is loaded using a configuration tool.

The GC 34 includes data fields for common user attributes that have a fixed configuration, but which are field-populated using a configuration tool or an appropriate user application. The common user attribute fields preferably include: an area name field, which preferably includes one line of fifteen characters; an owner/company name field, which preferably includes one line of fifteen characters; a location field, which preferably includes three lines of fifteen characters each; an assigned-to field, which preferably includes an indication of an asset or function the GC 34 is associated with and preferably includes two lines of fifteen characters each; and another data field, which preferably includes four lines of fifteen characters each. Common user attributes are readable over the network, e.g., in response to a configuration tool inquiry, or via an appropriate user application with appropriate authentication.

The GC 34 includes power-on self-test (POST) functionality, which includes a programmed script that runs when first turned on for purposes of checking basic, minimally-required operating behavior. Errors and/or exceptions are reported if detected. The GC 34 is also equipped with diagnostics, initiated by command via a user interface, e.g., a user application or configuration tool, capable of testing or detecting: operating system anomalies; TX & RX operation of all transceivers; LAN connectivity; and WAN connectivity. The GC 34 maintains and stores statistics and peg counters that can be read and reset remotely to aide in performance monitoring, including, but not limited to: POST anomalies; latency; a percentage of instances that RSNs are awakening due to in-band noise; a percentage of instances that RSNs are awakening due to wrong-class requests; a percentage of initial message failures; an average number of message retries; and an average number of hops.

The GC 34 is configured to be capable of rebooting its gateway server upon command, either wirelessly or via a wired line. This command is issue-able only by the affected network owner or administrator. The GC 34 preferably also includes a fail-safe means of rebooting the gateway server that can be effected in the absence of wireless or wireline connectivity, such as, for example, a power interrupt. Preferably, however, no means or method of server rebooting corrupts settings, configurations, or stored data.

The GC 34 includes an audio codec and low-level analog circuitry capable of playing prerecorded, messages stored digitally onboard. The messages are downloadable via a configuration tool. The messages are played back via an external audio speaker connected through a port on the gateway controller housing. Messages are played upon command of a user application. Preferably, messages are at most ten seconds long, and comprise low-fidelity, e.g., AM-radio, speech. Preferably, fewer than ten messages are stored at any one time.

The GC 34 includes a reduced complexity radio (RCR), i.e., a wake-up transceiver, together with one or more appropriate internal antennas. Preferably, this RCR is part of gateway router hardware of the GC 34. The RCR is normally in a dormant state in which it is ready to receive an incoming transmission, but is not ready to transmit. When in the dormant state, the RCR awaits an event input or an appropriate wake-up message. The RCR generally functions in accordance with RCR technology as described both hereinabove, and in several of the references incorporated herein.

The GC 34 is further configured in accordance with class-based networking as described in many of the incorporated references, as well as elsewhere herein, such that an appropriate wake-up message is preferably an in-band wake-up message associated with a Class that the GC 34 belongs to. The RCR is configured to communicate using messages having a total message length sufficient to provide Class functionality, reliability, a payload, authentication, routing functionality, error correction, and other data or instructions as needed to ensure that the GC 34 communicates with only in-Class networks and in a manner appropriate to those networks and attendant applications, which may be user applications or otherwise.

The GC 34 is configurable to operate in one of three operational modes. In a private mode, the GC 34 is configured to respond to a fixed set of classes, which fixed set can be modified and updated. In a public mode, the GC 34 is configured to respond to any class. Lastly, in a shared mode, the GC 34 is configured to respond to a fixed number of classes, selected by the owner of the GC 34. Preferably, in this shared mode, whether the GC 34 responds is based at least in part upon the identity of the user or owner of the asset sending a message, as described in a user-ID portion of the message header. Preferably, this identity is verified by a DNS query.

The GC 34 includes a Bluetooth radio, i.e., a complex transceiver, configured in accordance with IEEE 802.15, together with one or more appropriate internal antennas. Preferably, this Bluetooth radio is part of gateway router fware of the GC 34. The Bluetooth radio is normally in an off state until turned on by a command from the onboard controller, e.g., a command triggered by the need to communicate with an RSN.

Preferably, both the RCR and Bluetooth radio, using their internal antennas, have a range, for communications with the RCR or Bluetooth radio of another RSN, or of a gateway router or GC 34, of at least three hundred feet in the most challenging RF environment contemplated for the target applications. Similarly, both the RCR and Bluetooth radio preferably enjoy an open-space, line-of-sight range of at least eight hundred feet, and more preferably enjoy an open-space, line-of-sight range of at least 300 meters.

The GC 34 includes at least one Wi-Fi transceiver configured in accordance with IEEE 802.11, together with one or more appropriate antennas, for backhaul communication and for communications with user-interface devices and other gateway controllers. Preferably, this Wi-Fi transceiver is part of gateway router hardware of the GC 34. Wi-Fi is available for electronic communications with local user devices, such as, for example, a laptop or PDA running a user application.

Preferably, in an office or an urban environment, Wi-Fi range is at least 300 feet, while in open areas, Wi-Fi range is preferably at least 800 feet, line-of-sight, and more preferably at least 300 meters, line-of-sight. The number of transceivers and operating bands is preferably engineered to minimize the likelihood of in-band interference disrupting network performance.

The GC 34 is configured for 10/100 Ethernet connectivity. Ethernet connectivity is provided through a connector on the gateway controller housing. The connector preferably conforms to a commonly available, industry-standard design, suitable for Ethernet connectivity and environment requirements. The connector interface includes an automatic cable polarity detection switch, such that either straight or crossed cables may be used for interconnection. In at least some implementations, both gateway router hardware and gateway server hardware includes Ethernet connectivity.

The GC 34 is preferably capable of being quickly modified to allow for the use of GSM/3G/4G (or later version) or CDMA bi-directional data communications. This may be accomplished, for example, via insertion of a card by a technician, and the use of a configuration tool. The GC 34 contains internal, customer configurable logic that allows the GC 34 to establish connections based upon: an elapsed time since a previously established successful connection; a set periodic interval; the occurrence of some number of ‘buffered’ messages.

The GC 34 is preferably capable of being quickly modified to support a 9.6 KB/sec. bi-directional serial link, which can be used to interface with external satellite or Land-Mobil Radio (LMR) devices. This may be accomplished, for example, via insertion of a card by a technician, and the use of a configuration tool. This functionality is capable of being implemented with hardware flow-control.

Gateway router hardware of the GC 34 is capable of providing point-to-point, bi-directional gateway functionality within a local network island via WiFi, LMR, fixed terrestrial RF link, or satellite, if equipped with one or more appropriate cards or modules as described. Preferably, these links will appear to be ‘nailed-up’, i.e., non-dialup, connections, that exhibit latency consistent with other timeout and re-try time intervals established for the overall system. Gateway router hardware is configured to store in non-volatile memory the addresses of wireless link LAN and WAN connections.

The radios of the GC 34 preferably transmit at a power and frequency acceptable in all jurisdictions in which the GC 34 is intended to be operated. If the radios are not inherently compliant for all jurisdictions, the GC 34 preferably includes one or more tables or rules to govern gateway controller and RSN operating frequencies and transmit power levels for non-US jurisdictions. The selection of power levels and frequencies is preferably governed by a fixed selection made using a configuration tool, or based on current GPS coordinates.

Each internal radio preferably exhibits a generally omni-directional radiation pattern. Radiation patterns are preferably optimized in anticipation that the GC 34 is likely to be in close proximity, e.g., less than one half of an inch, with a conductive surface. Preferably, the GC 34 is mounted such that a narrow side of the gateway controller with connectors is facing downwards.

The GC 34 is configured to communicate with user-input devices, e.g., a laptop or PDA, and is preferably configured to recognize and authenticate such user-input devices. For example, this functionality might be achieved utilizing a stored list of unique identifiers of specific trusted user devices or accepted passwords and encryption keys, where any user device that does not have a matching identifier or accepted password or key shall not be permitted to communicate with the GC 34, and the identifiers, passwords, and keys are configurable using a configuration tool, but not user applications. Such functionality may be implemented in a similar manner as commercial Wi-Fi routers. Such functionality preferably applies to both wireless and wired communications, but may differ for each.

As noted hereinabove, radio networks are configured to allow for “hopping” between RSNs and other network devices. The GC 34 includes hopping algorithms and rules such that up to 16 hops can be managed, using appropriate Classes, with appropriate priority.

The GC 34 further includes message-handling algorithms and rules configured such that messages to or from RSNs or other gateway controllers are queued, messages are handled with appropriate priority, and no critical messages are inadvertently lost.

This functionality is applicable both among RSNs and gateway controllers of a local network island, and between a local network island and other networks, e.g., to or from a WAN.

The GC 34 is configured to support the management of RSN behavior-states as required to meet the needs of a network and user applications.

The GC 34 is programmed with operating parameters and instructions that are designed to: minimize instances of the local network and its RSNs responding to mass events, e.g., earth quakes, thunder, passing rail traffic, high winds, etc., avoid network paralysis; and prevent RSNs from wasting battery life with useless messages.

The GC 34 is further configured to collect and store event data records automatically, and to upload such EDRs via a WAN connection to appropriate servers and applications. Such uploading preferably occurs upon receipt of an EDR from another device or process when WAN connectivity is available, when a user-set time has a expired, when a user-set number of EDRs have been buffered, or upon command from a user application.

If WAN connectivity is not available, then EDRs are buffered until connectivity is re-established. If buffer capacity is exceeded, then buffered EDRs are discarded in a first-in-first-out manner. EDRs preferably include an EDR type, and in such event, EDRs are discarded in a first-in-first-out manner by EDR type.

The buffer is configured such that it has sufficient capacity to store, at least 2400 EDRs. The buffer medium is non-volatile. The GC 34 otherwise is capable of storing EDRs indefinitely until uploaded. Once uploaded, buffered EDRs may be cleared.

Notably, EDRs are handled by the GC 34 so as to not interfere with other messaging, e.g., control and status messaging. EDR functionality is configured to minimize the effect of EDRs on GC 34 and network loading. If EDR types are utilized, EDRs preferably are handled with priority based upon EDR type.

The GC 34 also preferably includes a GPS receiver. The GC 34 is configured to report its GPS coordinates, i.e., GPS data, to remote applications via an onboard or external WAN connection.

The GPS data is capable of being sent upon request from the MMR system, another gateway controller, or by command that originates from either a remote or a local user application, e.g., in response to a user pressing a send-this-location button on a keypad in the operator's cabin of a port's rubber tired gantry (RTG).

GPS data is included in all inbound EDR messages. The data corresponds to the GPS-enabled device that is physically closest to the asset that originates the EDR, within the constraints of network connections.

Preferably, the GPS receiver outputs almanac, ephemeris, and timing information potentially for use by RSN GPS sleds, for network-aided GPS operation.

The GC 34 includes a clock, which is synchronized with GPS time. Time is reported or recorded for use by applications utilizing 24-hour GMT, plus a date indication. All records requiring a time stamp is stamped per this time and date.

The GC 34 synchronizes to GPS time, assuming it has satellite visibility, each time GPS coordinates are reported to any application, and at least once every 24 hours. The GC 34 may keep or measure time by any method, but preferably the clock is accurate to within plus or minus five seconds per day.

Clock operation and reporting is settable to a local time zone via the MMR system, a configuration tool, or appropriate user applications; automatically adjusts for daylight savings time; is aware of the day of the week; automatically adjusts for leap years. The GC 34 clock is used to update RSN clocks, as described hereinabove.

The GC 34 preferably weighs less than four and a half pounds even with a full suite of WAN radios and a gateway server module.

From the foregoing description of the GC 34, it will be appreciated that gateways constitute part of the network infrastructure that supports communications between RSNs and asset management applications. In particular, gateways serve as an access point for RSNs in a local onsite network and establish the basic coverage area at a given site. Since RSNs serve as nodes in a localized wireless network, gateways manage the network of RSNs. In addition, gateways provide access to and manage communication between the local RSN networks and Wide Area Networks (WANs, like the Internet) that interface with application software. Gateways may be mounted on selected vehicles and/or at selected fixed locations, getting power from the vehicle or from power available at the fixed locations, respectively. Gateways may be affixed to a construction site trailer or other structures at a construction site where coverage is ample for that location. Vehicle-mounted gateways may be affixed to a foreman's vehicle, for example. Gateways have bi-directional radios that communicate with the RSNs, and other bi-directional radios (or wireline capability) for communications outside the local RSN networks using other services (e.g., to WANs, via Wi-Fi, mobile phone, satellite, etc.), and fixed gateways may be networked together via broadband wireline Ethernet or DSL links commonly available at fixed sites. Gateways are also equipped with data-storage media to store site event data, and are equipped with a GPS receiver to pinpoint the location of the gateway.

### Servers and Asset Management Application Software

Servers host the asset management software applications for tracking and monitoring the assets with which the RSNs are associated. In this respect, a “server” represents one or more networked computer on which the asset management application (and preferably the associated data storage) resides and which provides access to those applications for users managing the assets.

Moreover, user access preferably may be by local network and/or the Internet. Servers also host system and network-management applications such as configurators, which are used to initialize, setup, modify, and maintain the RSNs and gateways of the system.

A one-to-one correspondence of RSN to asset preferably is created and maintained by an asset management software application communicating with the RSN. In this regard, each RSN preferably has a unique identifier (UID) and, in typical deployments, each piece of equipment is permanently assigned an RSN. That is, each RSN is uniquely identified and associated with a single piece of equipment, and vice-versa, whereby the UID of the RSN preferably is used to identify the asset, too. Identification and pertinent data about the asset with which an RSN is associated preferably is stored in the database of the application and may further be maintained by the RSN itself.

In operation of a preferred system, and as noted hereinabove, a radio network can be configured by a gateway controller to cause RSNs attached thereto to send quasi-periodical check-in messages to indicate its continued presence to a gateway controller. The gateway controller preferably knows when to expect such messages, and if a certain number of these messages are not received within some defined period, then the gateway controller preferably sends a message to a customer (e.g., to the customer's asset management software application) notifying the customer that the asset associated with the RSN that failed to check-in is currently unaccounted for on site.

### Message Management and Routing (MMR) Component of the Preferred System

The network infrastructure of the preferred system also includes a message management and routing (MMR) component that serves to insure that messages to/from asset management applications and databases on the one hand, and the RSNs on the other, are correctly delivered there between to the intended recipients. In this respect, as each radio network is discrete and preferably is controlled by a single gateway controller, gateway controllers preferably communicate with an MMR component of the system through an application program interface (API) when sending messages to asset management software applications on client servers and, similarly, asset management software applications running on client servers preferably communicate the MMR component via an API when sending messages to RSNs. The MMR system thus serves as an intermediary for communication between radio networks on the one hand, and servers and customer applications on the other.

An MMR component (sometimes also referred to as a “system”) is briefly described below, and additional information on MMR systems is the subject of, and can be found in, one or more of the incorporated priority patent application documents.

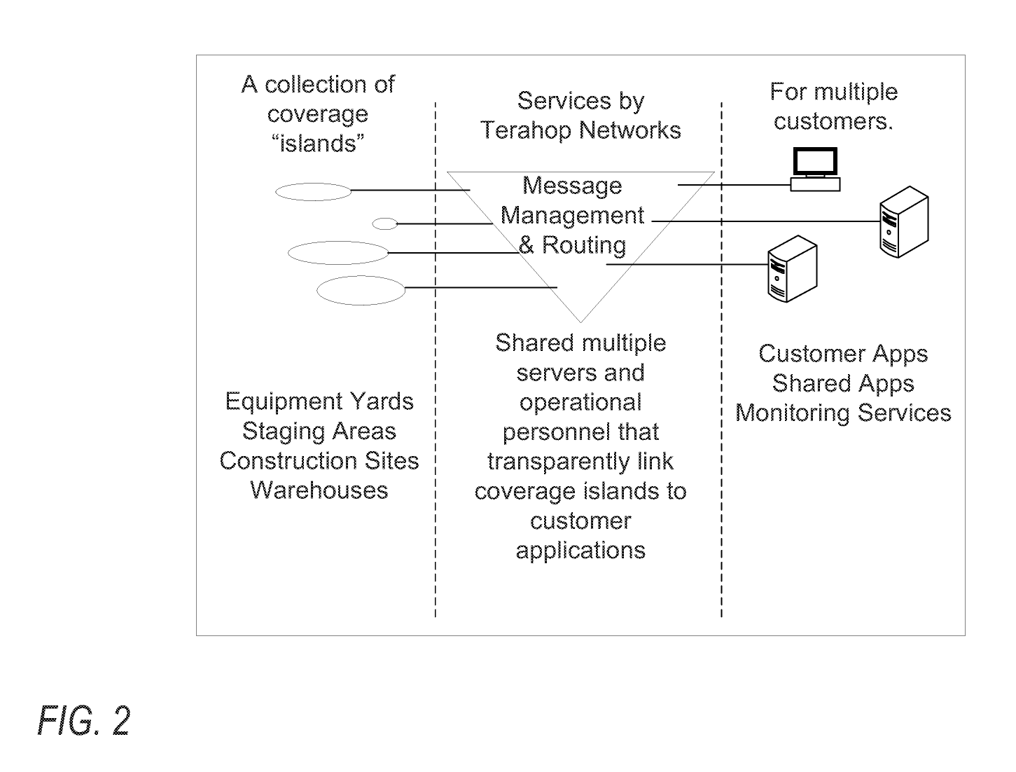

An MMR component of the preferred system is illustrated in FIG. 2 and is illustrated as being provided as a service by a managing entity, in this case called “Terahop Networks”. As shown, a plurality of discrete wireless islands are linked through common message handling components and are capable of presenting common access and views to multiple customers. Specifically, in FIG. 2 the illustrated system is divided into three logical segments. The left logical segment comprises the plurality of discrete wireless islands. The term “island” is used to emphasize that each is separate and distinct logically, even if one or more islands physically overlap in coverage. These islands may include both radio networks of RSNs as well as complementary networks, and the radio networks, preferably utilize the aforementioned CBN and WU technologies. The right logical segment comprises customer connectivity elements, including customer applications, as well as network management and configuration servers.

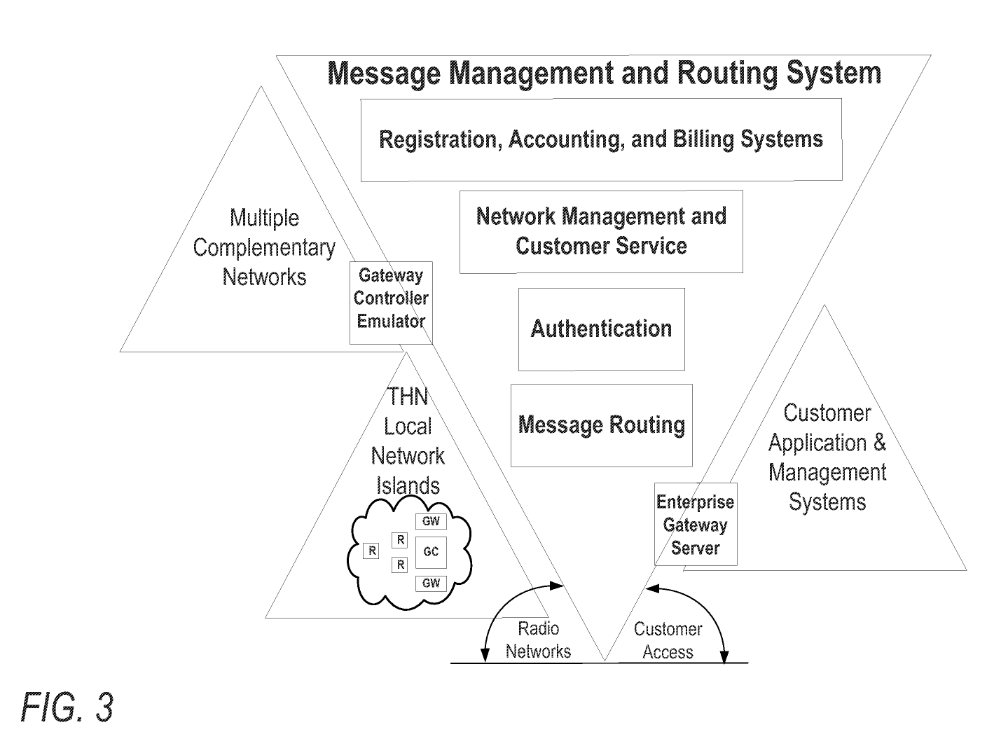

As illustrated in FIG. 3, the MMR component includes four functional blocks, namely: a registration accounting and billing systems block; a network management and customer service block; an authentication block; and a message routing block. Each of these blocks represents a logical subsystem (which may itself be comprised of multiple logical subsystems), and each subsystem may reside on separate platforms or may be integrated. In some implementations, multiple instances of one or more of the subsystems are utilized.

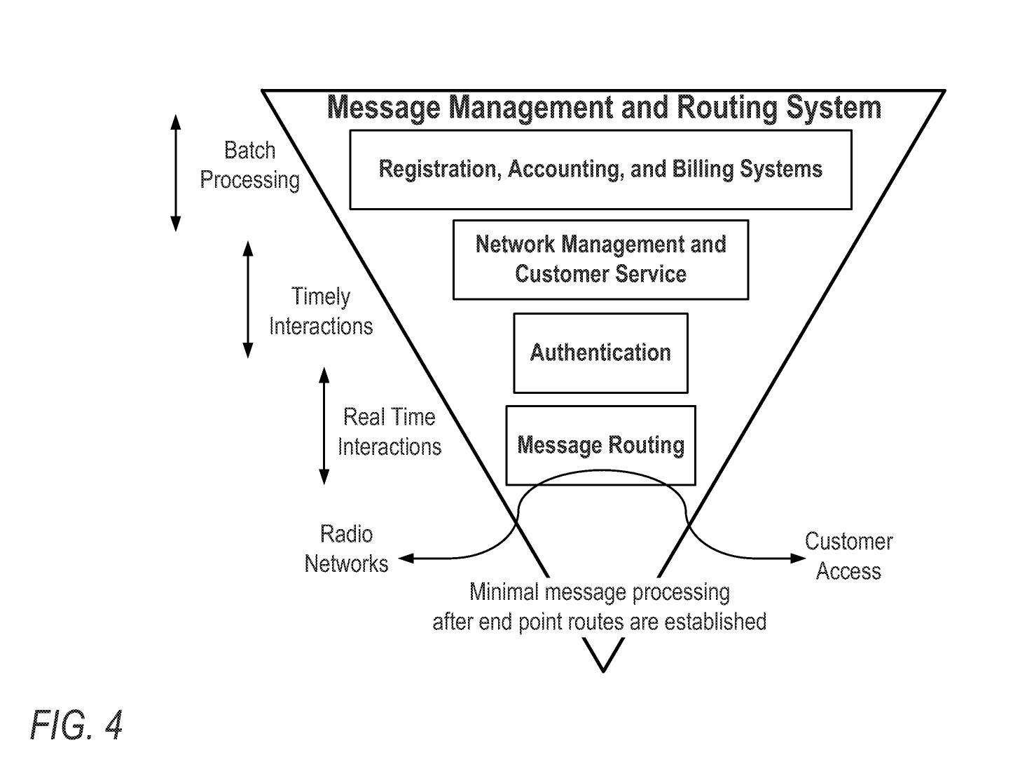

Notably, the vertical ordering of the blocks in FIG. 3 generally indicates the latency requirements of each corresponding logical subsystem, as can be seen in FIG. 4.

The upper most block corresponds to one or more subsystems that accumulate event-driven data and operator-entered data and primarily process it in batch modes. The block below the upper most block corresponds to one or more subsystems that require “timely” latency and response time that generally involve responses to human inquiries following a classic client-server metaphor. Reasonable response times are required when queries are initiated by humans. In general, queries and responses are queued with round trip delays in the order of three to six seconds. The lower most block corresponds to one or more subsystems that require real time message processing with minimum latency. These elements are heavily involved in most application message transactions. Their performance will characterize the entire system. The authentication block, or functional layer, shown in the middle of the diagram provides authentication and access control for all elements within the network and all edge devices. In some instances, it will be involved in all requested transactions. In other cases, it will be involved on a once-per-session basis only. Notably, this is in addition to the authentication provided by EGWs as described hereinabove. Thus, the authentication functionality of the MMR component manages access only on a macro level for each customer under the assumption that the EGWs will contain business rules and control individual application and user access.

The architecture of the MMR component is designed such that messages containing data traveling between an RSN and user application are handled in real time with minimal practical latency, but an event data record (as described hereinbelow) that audits this transaction is queued or stored and forwarded for delivery when resources are not stressed.

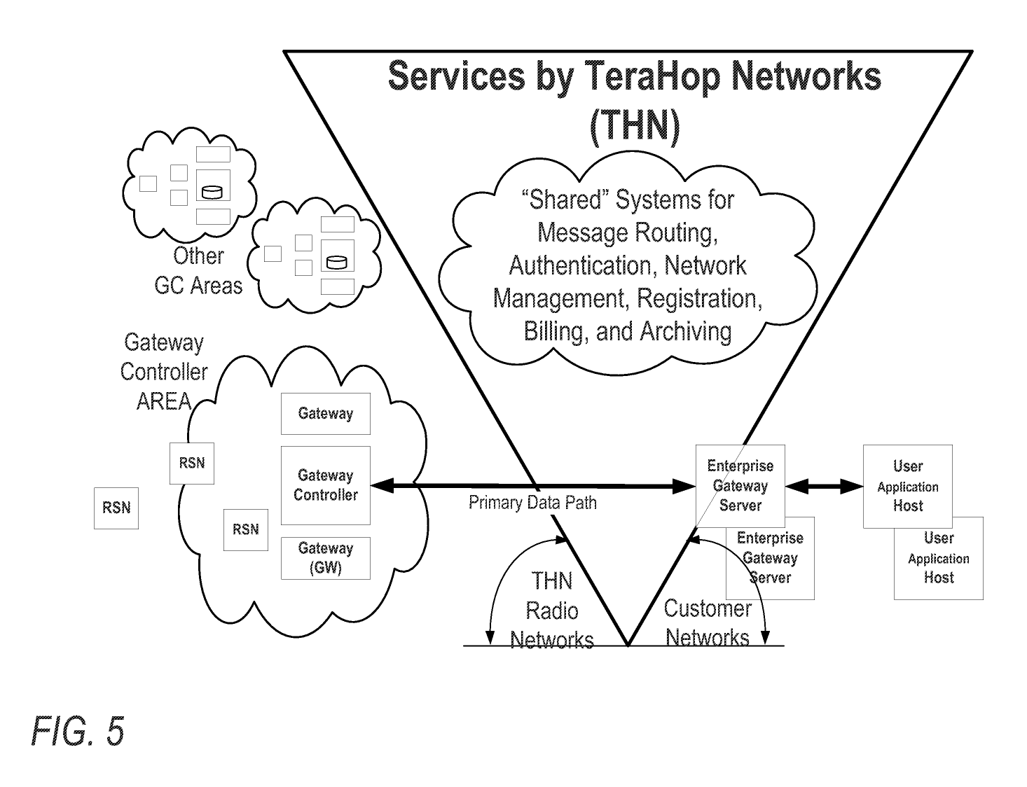

FIG. 4 additionally illustrates the flow of data between a wireless island, in this example a radio network, and a customer application host. These flows are illustrated in the bottom of the figure with the dual ended arrow that links the radio networks and customer access. Note that the flow is illustrated as passing through a bottom portion of the message routing block, or functional layer, of the MMR component. This depiction represents the idea that the MMR component is minimally invasive to data flow. In this regard, the MMR component operates similarly to Session Initiation Protocol (SIP) in a VoIP network by receiving a request to route information, validating the request, and then returning a routing address. After this process is complete, the MMR component is no longer involved in the actual data transaction. For example, in order to enable communication between a radio network and a customer application, the MMR component routes addresses to both a gateway controller of the radio network and an EGW associated with the customer application, at which point communications between the radio network and the user application will follow the primary data path illustrated in FIG. 5. This approach minimizes latency and is highly scalable.

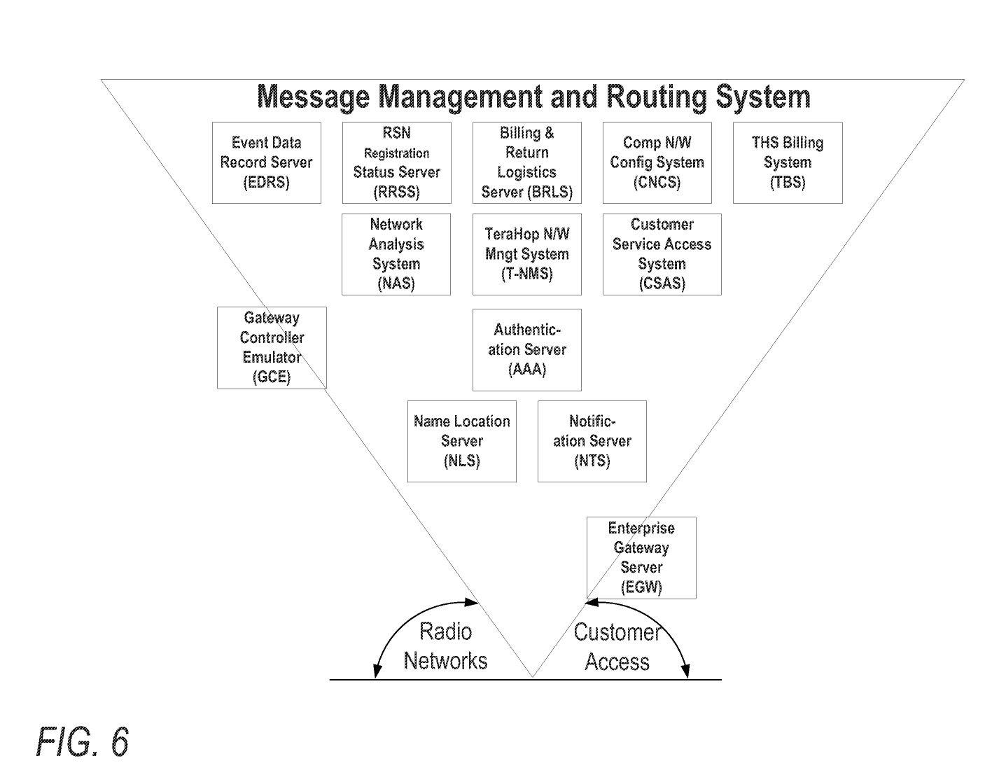

FIG. 6 is a more detailed reference model illustrating logical subsystems of an exemplary implementation including the MMR component. GCE and EGW edge devices are shown for completeness. At each functional level, each subsystem, i.e., each labeled block, represents a logical element that may or may not be implemented as a standalone hardware system. Further, larger or more complex implementations will require multiple instances of one or more subsystems. Notably, at least some implementations will not require one or more of these subsystems, such as for example private systems which might not require a billing subsystem. In such implementations, all subsystems are preferably still at least programmatically “stubbed out” so that they can later be added in easily. The vertical placement of the subsystems within FIG. 6 differentiates the latency and response time requirements for each subsystem, as previously described.

Each functional subsystem is described in more detail in the incorporated priority patent application documents, such as U.S. Ser. No. 12/647,040.

### Mobile Gateway Controller

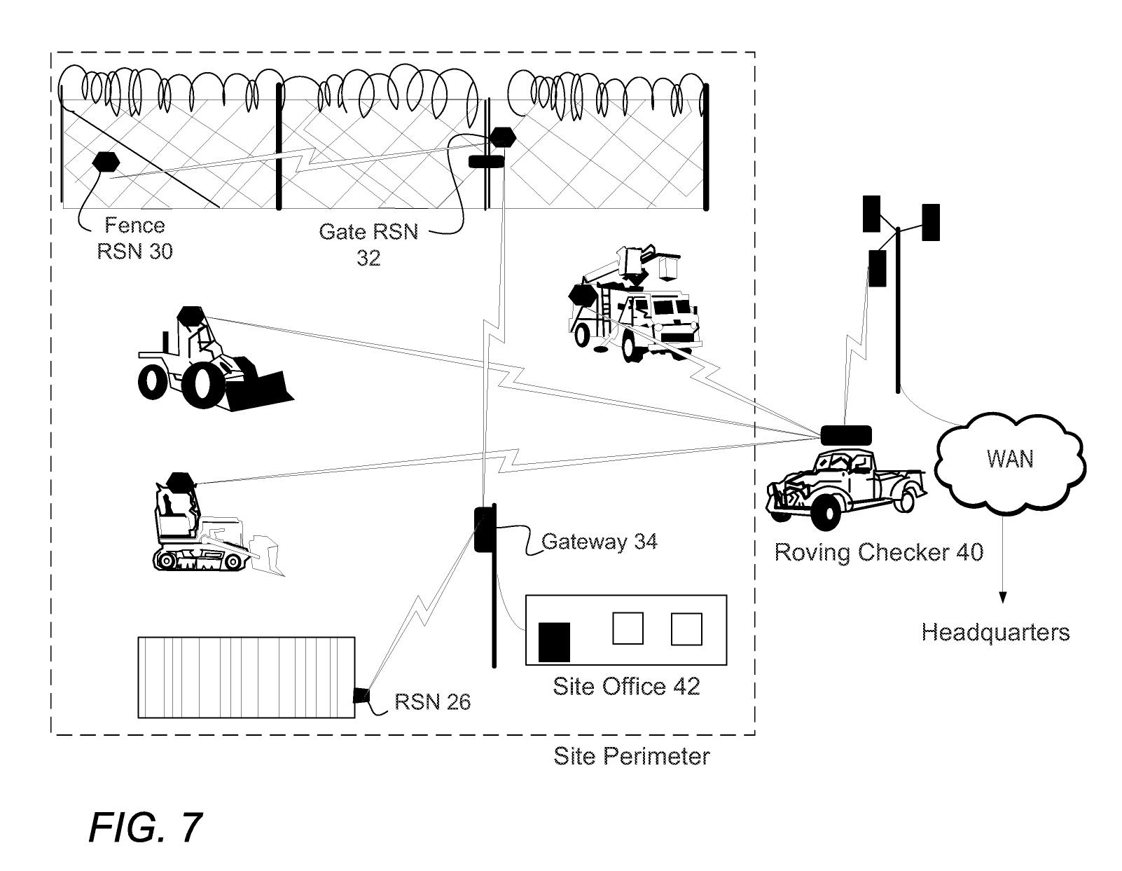

With reference to the hypothetical scenario given below, FIG. 7 illustrates a system used to managed and secure construction equipment in accordance with a preferred embodiment of the present invention, wherein a mobile gateway controller in the form of a “roving checker” 40 is used to communicate with the RSNs at the construction site that are attached to the rental equipment of Heavy Duty Rentals.

Generally, a mobile gateway, controller is used because either no fixed gateway controller is present at the site or not gateway controller is present with which the RSNs of the rental company can communicate. Indeed, in FIG. 7 the illustrated onsite gateway 34 is owned by the construction company on site and is configured only to communicate with the perimeter RSNs 30,32 and the storage container RSN 26, thus necessitating the use of the roving checker by the owner (e.g., rental company) of the heavy duty construction equipment.

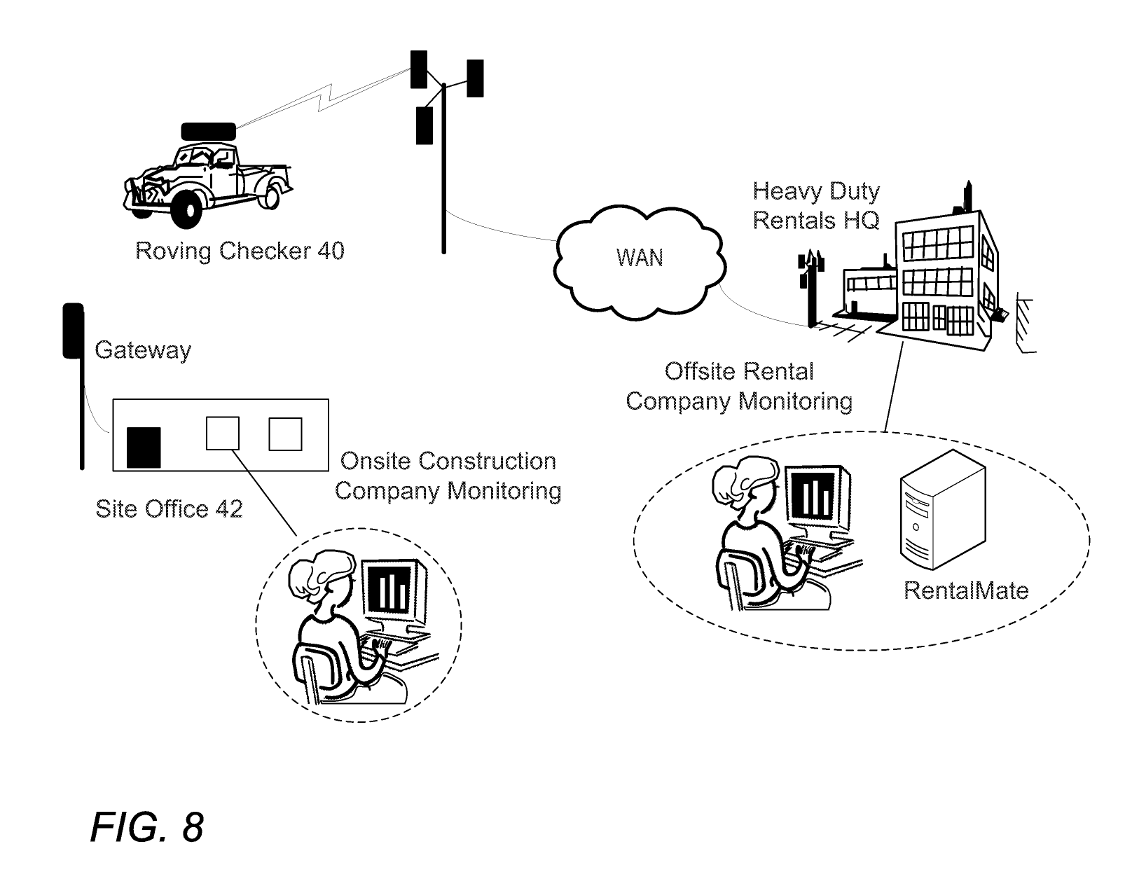

FIG. 8 illustrates additional portions of the system of FIG. 7, wherein both onsite and offsite monitoring by the different companies are illustrated. It will be appreciated that the onsite monitoring by the construction company may be performed as shown without use of an MMR component. In contrast, both companies could perform the same monitoring in connection with the system 10 illustrated in FIG. 1, but such would require the MMR component so that communications to and from the perimeter RSNs 30,32 and the storage container RSN 26 would be from and to (respectively) the server/application software of the construction company, and communications to and from the RSNs attached to the rented equipment would be from and to (respectively) the server/application software of the rental company.

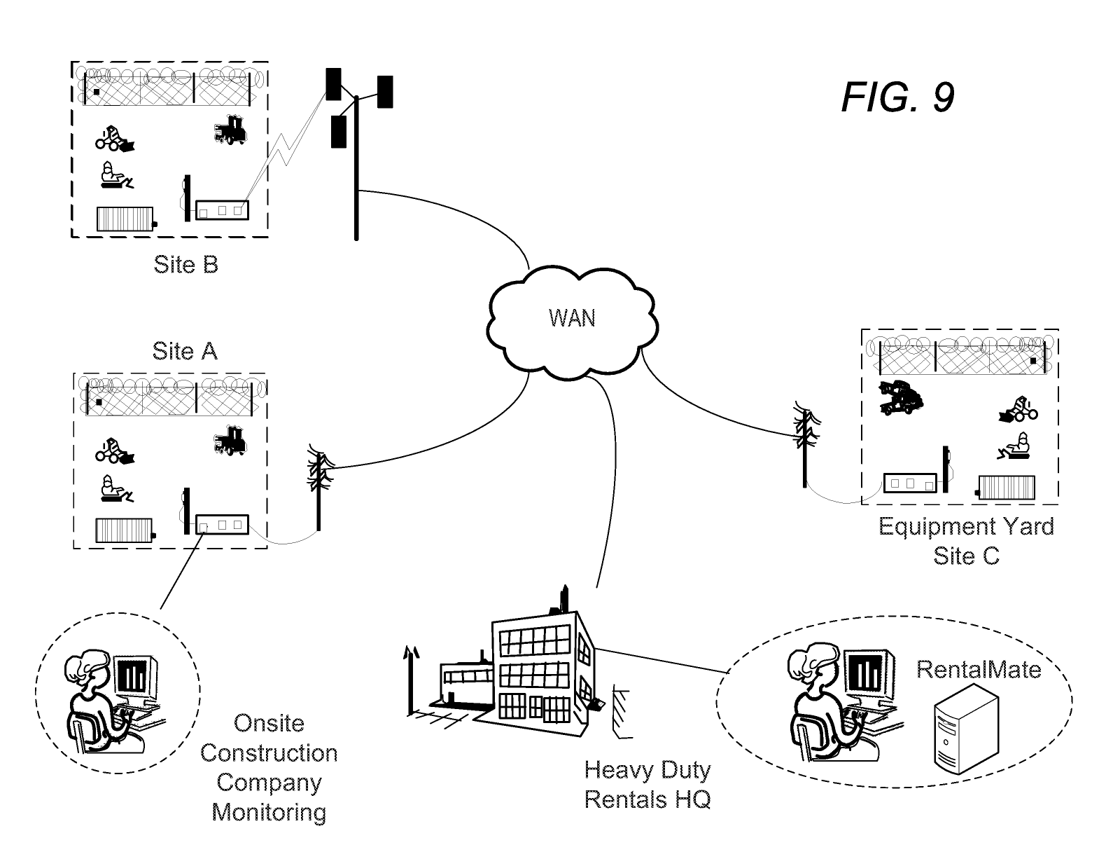

Continuing with the reference to the hypothetical scenario given below, FIG. 9 illustrates a system used to managed and secure construction equipment at multiple sites of the same construction company (i.e., site A and site B). In FIG. 9, however, the construction company monitors its equipment and secures the different construction sites by running its application software on its server at site A, which is remote to construction site B. Furthermore, both site A and site B include public or shared gateway controllers by which communications are effected from and to RSNs at the sites. As will be appreciated, in this situation the MMR component is utilized to properly direct communications between RSNs at the sites and the construction company versus the rental company.

FIG. 9 further illustrates the equipment yard of the rental company (site c), where a private gateway controller is provided. Heavy Duty Rentals utilizes this gateway controller for tracking and monitoring the equipment at this site as well as monitoring the security of the perimeter of the site. Any other construction sites at which its rental equipment is in use, and that does not include a usable gateway controller, may be serviced by the roving checker of FIG. 8.

FIG. 9 also illustrates both wireline communications between the gateway controller at site A and the external network (preferably over a broadband cabled or DSL connection), and wireless communications between the gateway controller at site B and the external network via cellular communications or WiMAX/4 G communications.

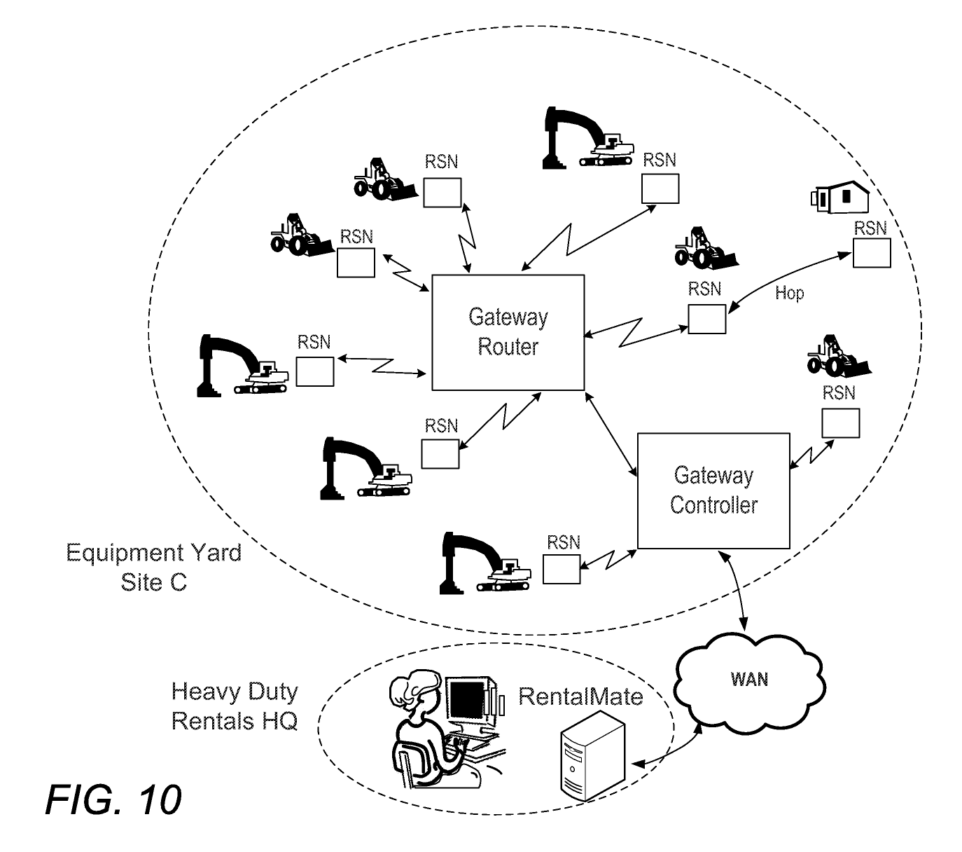

FIG. 10 illustrates a gateway router used in conjunction with a gateway controller for expanding the area coverage for radio networks at the equipment yard (site c) in FIG. 9, where Heavy Duty Rentals stores its rental equipment when not being used. It will be appreciated that FIG. 10 illustrates the use of a gateway router to expand the wireless coverage area of the gateway controller. Additionally, RSN hopping is illustrated, which further increase the coverage area at the site.

### Detailed Description

### Construction Equipment Implementation—Exemplary Scenario

This following describes a hypothetical scenario in which a preferred embodiment of the present invention is deployed and used to manage and protect construction equipment at a large construction site and at a rental yard.

A major renovation project is taking place in a run-down area in Benson, Ga. The project is to include the demolition of an existing housing project, which has been previously gutted, and replace it with the construction of a middle-class high-rise apartment complex. In order to improve their chances of winning the contract, Demo-Rite Construction and We-Haul Services have teamed up to bid on the demolition portion of the contract. Demo-Rite Construction is much smaller than We-Haul Services, but, through a personal relationship between the owners, We-Haul Services agreed to the joint bid.

As a result of this partnership, the team has been awarded the demolition and clearing portion of the project. As Demo-Rite Construction is a relatively small company, the award of this project will be a significant undertaking and will stretch their human and physical resources. Being a small family-owned company, Demo-Rite Construction typically demolishes small structures and utilizes small equipment to accomplish those jobs. The demolition of the multi-story housing project will require equipment and resources currently not owned by the company, and they do not have the resources to purchase the necessary equipment. So, in order to meet their equipment requirements, Demo-Rite will need to rent the necessary equipment.

Demo-Rite Construction has a great deal of concern over renting the necessary equipment. In a previous project where they had to rent equipment, they experienced extensive project schedule over-runs that, in addition to penalties from the customer, led to major penalties from the rental company when the contract-specified run-time-hours limit of the rented equipment was exceeded. So, Demo-Rite Construction will need to diligently manage the rented equipment's usage if they are going to manage costs and make money on this project. Also, they will need to make sure that nothing happens to the equipment after hours.

In order to meet their equipment needs, Demo-Rite Construction contracts with Heavy Duty Rentals. Demo-Rite Construction has estimated that the housing demolition will require three pieces of equipment that they currently do not own: two excavators, one with a hydraulic hammer; and one skid steer loader with a hydraulic hammer. Heavy Duty Rentals has recently implemented a preferred system in accordance with the present invention in order to help it manage its rental assets among their several yards. The preferred system is provided by Terahop Networks, which entity manages data communications between software supplied to Heavy Duty Rentals and data from the field. By placing a RSN on every piece of rental equipment, Heavy Duty Rentals has the ability to know automatically, accurately, and in near-real-time what equipment is available, where the equipment is located, and the run-time history of each unit. They also receive near-real-time alarms if any unit is unexpectedly moved or subject to tampering.

Prior to implementing the preferred system from Terahop Networks, Heavy Duty Rentals relied solely on records as maintained in a software application that was used to manage its rental equipment. In particular, the software—called “RentalMate”—maintained records based on manual data input by employees of Heavy Duty Rental. The data was input as equipment was rented, returned, and maintained. Since the records were based on manual inputs by employees, the data frequently included errors. Moreover, the data was also often several days old, and, therefore, sometimes unreliable. Due to the unreliability, Heavy Duty Rentals frequently had to send people out into rental yards to visually inspect and confirm inventory as reported by RentalMate. The poor data records led the company to: make rental agreements for equipment that was, in fact, unavailable; lose opportunities to rent when desired equipment was actually available; require customers to wait until equipment could be found or became available before such equipment could be rented; incur added operational costs to inspect inventory and make subsequent corrections to the records in the RentalMate database; increase rental costs due to increased labor and operating inefficiencies; and lose repeat business due to poor customer rental experiences and service.

When Demo-Rite Construction calls, Heavy Duty Rentals uses RentalMate in conjunction with the preferred system supplied by Terahop Networks to learn that it has an excavator with a hydraulic hammer in the service yard in Macon, Ga., and another one at a job site in Rome, Ga. In addition, the RentalMate software informs the rental manager at Heavy Duty Rentals that he has the necessary bucket in his local rental yard to retrofit one excavator. The software also informs him that he has two skid steer loaders in stock in the rental yard and that they are available immediately. Heavy Duty Rentals further is able to offer Demo-Rite Construction the equipment with the fewest run-time hours, which will minimize maintenance and service downtimes.

While completing the rental transaction with Demo-Rite Construction, Heavy Duty informs Demo-Rite Construction that the use of the Terahop Networks system is included with each rental agreement, whereby Demo-Rite Construction will be able to monitor whether the rented equipment is on site, automatically receive alarms if there is a security event after hours, and also manage run-time hours for budget management. Due to Demo-Rite Construction's past rental experience and due to the fact that the rental agreement includes run-time provisions that factor into the cost of each unit rented, Demo-Rite Construction is excited about this added service and the expanded functionality that will help to manage its project costs. In addition, Demo-Rite Construction is pleased to learn the Terahop Networks system will require minimal set-up and will be usable wherever the project site may be.

### Hypothetical Scenario

### Breaking Ground—The Project Begins

The construction project has been progressing on schedule. All perimeter fencing has been installed, and the existing building where the new apartment complex is to be constructed has been readied for demolition. The crews are in the process of completing all final preparation tasks as demolition will begin shortly. Heavy Duty Rentals has delivered the demolition equipment on schedule. Demo-Rite Construction was pleased to learn that the general contractor for the site has already installed a Terahop Network gateway for his use. When Heavy Duty Rental's equipment arrived at the construction site, the equipment was immediately recognized by the gateway, and its arrival was automatically reported to Demo-Rite Construction's asset management application. Using the asset management application, the Demo-Rite Construction foreman clicked to manually accept the equipment into the local network (and to accept custody), and the acceptance was automatically relayed to the RentalMate application of Heavy Duty Rentals.

Demo-Rite Construction's foreman is anxious to see how the system works. Since the apartment complex is in a part of town identified for reclamation, crime in the area has been high, and the construction site has previously been plagued with several equipment thefts. The foreman is hoping that, with the RSNs installed, thieves will be deterred from entering the yard and stealing any more equipment.

Just as the team is getting ready to begin the demolition phase of the project, the Environmental Protection Agency (EPA) visits the construction site and raises questions concerning the permits issued to complete the job. As the prime construction company works through the issues with the EPA over the next couple of weeks, the project quickly gets behind schedule.

Eventually, all issues are resolved, and the team is ready to begin the demolition process. The original plan was to use Demo-Rite Construction's smaller equipment to break down portions of the building. This would have taken longer, but the company would have been able to use the majority of its own equipment to complete the tasks, thus limiting the usage of the rental equipment. However, due to the permitting delays, the team has suddenly found itself behind schedule, and the foreman has decided to use the rental equipment from Heavy Duty Rentals for the entire demolition project. He has also decided that he will require two additional pieces of larger equipment if he is to get the project back on schedule.

Contacting Heavy Duty Rentals about his additional need, Heavy Duty Rentals is able to use the preferred system to confidently assure, while they are on the phone, that the necessary equipment is available and in the rental yard. They agree to have the equipment on site within the next two days. Even with the extra equipment, Demo-Rite Construction fears that the demolition project will increase the planned usage on the equipment, possibly incurring penalties. However, those penalties are insignificant compared to those that will be incurred by completing the project late. With the preferred system, the Demo-Rite Construction foreman now has a tool that automatically helps him keep up-to-the minute tabs on that usage. Therefore, the foreman has ordered all demolition equipment to run double shifts until the building is demolished and cleared. The foreman feels confident that he can manage the run-time hours and stay below the contract limits on the rental equipment by closely monitoring the run-time data provided by the RSNs mounted on each asset and recorded in the asset management application.

Late the next day, the rental company arrives with the additional demolition equipment. Since each is pre-equipped with an RSN, the local gateway automatically detects its arrival and reports each to both the RentalMate application of Heavy Duty Rentals and the application used by Demo-Rite Construction. As before, the new arrivals are automatically reported and then manually accepted and entered into the respective systems.

The demolition continues to progress smoothly. As part of the project, We-Haul Services is on site for the debris hauling. We-Haul Services has arrived with several front-end loaders, debris pickers, and dump trucks. We-Haul Services has used the preferred system provided by Terahop Networks in the past and already has each piece of equipment equipped with an RSN. We-Haul Services' foreman is pleased to hear that the job site is already equipped with the gateway. By having assigned a separate class designation to his equipment's RSNs, he is able to utilize the local network infrastructure to monitor the equipment of We-Haul Services without affecting the separate monitoring capabilities of the general contractor or Heavy Duty Rental.

The Saturday night after We-Haul Services arrived on the site, a group of thieves arrive at the construction yard after hours looking to steal one of the front-end loaders. With all of the new construction in Asia, a shortage of heavy equipment has developed in that region, making it a prime market for thieves to serve by stealing equipment in the United States and having it shipped to prospective buyers there. By utilizing motion sensor capability, the general contractor has installed RSNs on a perimeter security fence around the construction site for detecting intrusions into the secure site. However, with the arrival of the We-Haul Services equipment, overcrowding has resulted in the construction yard, forcing several pieces of equipment to be temporarily parked outside the perimeter fence.

While several thieves are canvassing the construction equipment to identify a vehicle similar to the one requested from overseas, another is backing up a trailer onto which to load the equipment. While doing this, he inadvertently bumps into one of the parked pieces of demolition equipment. This sudden jar during non-operational hours causes the RSN associated with that piece of equipment to send a message that, several seconds later, results in an alert at the Heavy Duty Rentals corporate office, along with a notice being sent to the PDA of the construction site and Demo-Rite Construction's site foremen. Since the construction site is not guarded, and since the general contractor does not have a dedicated security firm at the construction site, an alarm such as this is configured to turn on additional site lights, initiate an audible alarm, and send a notice to the local police precinct. Upon hearing the alarm and being illuminated by the lights, the thieves rush to their vehicles and leave the construction site empty handed.

Having received the alarm on his PDA, the foreman for Demo-Rite Construction arrives at the construction site just as the police are arriving. Surveying the area, they find the tire tracks of the trailer and some minor damage on one of the pieces of demolition equipment, but find no major physical damages or loss of property. The police fill out a report, and the foreman resets the alarm and site lights, and returns home.

The next Monday morning, when Heavy Duty Rentals logs into their application, they notice the event alarm on one of their pieces of rental equipment. From the alarm message, they are able to tell to whom the equipment was rented; the piece of equipment from which the alarm was sent; the type of alarm sent; and the time of the event triggering the alarm. Reading this, Heavy Duty Rentals quickly contacts Demo-Rite Construction's foreman on his cell phone. The foreman explains what had happened and that the situation is under control. He also states that it was the vibration-detection ability of the RSN sensor that triggered the security alarm for the equipment and led to prevention of the theft. As standard operating procedure, Heavy Duty Rentals sends a mechanic to the construction site to inspect the equipment to insure no damage was incurred that was not visibly noticeable.

Also, hearing of the event of that night, the foreman for We-Haul Services drives to the construction yard with a mobile gateway-equipped vehicle and confirms all of We-Haul Services' equipment is present and none is missing.

### Hypothetical Scenario

### One Month Later

The demolition project continues to progress smoothly. The foremen were able to use the extra equipment and overtime hours to bring the project back on schedule. The run-time data for each asset provided by the preferred system allowed the Demo-Rite Construction foreman to manage the run-time hours closely and keep the overall project over-runs to a minimum. As a result of the scheduling, Demo-Rite Construction is able to return three pieces of heavy equipment back to Heavy Duty Rentals earlier than originally anticipated.

Nonetheless, there were two noteworthy events.

Due to an illness to one of their equipment operators and the tight timeframe to get the project back on schedule, Demo-Rite Construction needed to contract an operator for one of the pieces of equipment. During the course of the project, the contracting company invoiced Demo-Rite Construction for 12 hours of overtime work for their operator. The foreman, being confident in his scheduling practices, was certain he did not authorize the overtime for this particular operator. Checking the run-time data for the piece of equipment that the operator was assigned to, the Demo-Rite Construction foreman was able to verify that no such overtime had taken place. However, there were some anomalies that the preferred system helped verify with Demo-Rite Construction. The foreman brought the discrepancy to Heavy Duty Rentals' attention. Upon investigation, a clerical error was discovered—another customer had actually incurred the extra hours and the extra hours had been erroneously charged to Demo-Rite Construction.

Lastly, due to a miscommunication between Heavy Duty Rental's district office and the contracting company used to deliver and pick up the heavy rental equipment, Heavy Duty Rental's contractor arrived one day early to pick up the designated equipment. As Heavy Duty Rentals and Demo-Rite Construction were expecting the company to arrive a day later, the equipment's RSNs were configured for transport the next day. Therefore, as the contractor was leaving the construction site, the RSNs reported movement beyond and away from the site. Since the gateways and RSNs were configured to monitor the equipment's presence, when the equipment left the site, an alarm initiated. Realizing what had occurred and verifying that the alarm was for an unscheduled departure from the network and for the equipment that was being removed from the site, the Demo-Rite Construction foreman and Heavy Duty Rentals were able to acknowledge the alarm, recognize and acknowledge the early pickup, and no additional action was taken.

As Demo-Rite Construction concluded its need for extra equipment, upon returning the rented equipment to Heavy Duty Rental's yard, the gateways recognized the assets entering the network and automatically synchronized them with the onsite network infrastructure. Upon doing this, the RSNs on the assets downloaded all of the remaining device data into the gateway for download to Heavy Duty Rental's asset management software, whereby Heavy Duty Rentals may later review all recorded run-times for each piece of equipment and analyze any additional events recorded by the device. The run-time data is used to generate the final invoice to Demo-Rite Construction, as well as to schedule the appropriate maintenance for the number of hours run since the last rental equipment maintenance. Lastly, since the assets were now in their yard, yard inventory was updated, listing each of the returned assets as being available for new rental agreements.

### Hypothetical Scenario

### Demolition Complete

The demolition phase of the project has been completed. All site clean-up and grading has been wrapped up, and Demo-Rite Construction and We-Haul Services have left the construction site. All rental equipment has been returned to Heavy Duty Rentals.

Within the week of returning the equipment, Demo-Rite Construction received a final invoice from Heavy Duty Rentals. In the invoice was the amount due for the general contract hours, as well as a daily itemized list of the run-hours for each piece of equipment. This resulted in extra charges to Demo-Rite Construction for hours over-run. However, since Demo-Rite Construction had access to the usage hours on an on-going basis, they were able to confirm the invoice amounts and were able to process the invoice quickly and without question.

While using the preferred system provided by Terahop Network for the renovation project, Demo-Rite Construction recognized the importance of the information that was available as a result of the preferred system. Using the preferred system, they were able to automatically monitor the equipment that was onsite and confirm that all equipment expected to be onsite was, in fact, onsite. Demo-Rite Construction further was able to track run-time hours for each piece of equipment rented, allowing it to manage equipment over-runs, employee work hours, reduce equipment idling hours, and save equipment fuel. Demo-Rite Construction further enjoyed the added security provided by the preferred system when its equipment was at the construction site, even in view of the inadequate security provided by the general contractor. Lastly, Demo-Rite Construction liked that the data generated by the network integrated directly with its existing software applications and did not cause any significant changes in normal operating procedures performed by its employees.

These benefits led Demo-Rite Construction to subscribe to the preferred system provided by Terahop Networks for management of its company-owned equipment. Moreover, since Demo-Rite Construction was constantly dealing with theft of its own assets, Demo-Rite Construction installed a perimeter fence around its facility yard with RSNs attached. With the preferred system provided by Terahop Network in place, Demo-Rite Construction thus improved its own operational efficiencies and efficiencies in its asset management, allowing it to reduce costs, be more competitive, and, ultimately, more profitable.

### Final Comments on the Hypothetical Scenario

Generally, the preferred system of the hypothetical scenario is intended to automatically monitor the presence and condition of important assets. This function includes identifying where an asset is located (by what coverage area it is in), as well as monitoring run-time hours, and issuing alarms when something is amiss. In addition, the data provided from the system can be incorporated into asset-management applications to manage maintenance schedules, labor hours, and equipment programs. The alarms triggered by these data can be used to notify of a theft in progress or asset tampering, thereby enabling responses that can interrupt or deter such events. Should something unfortunate take place, the system provides accurate forensics, such as time and location of the events, to be used in the crime-solving or in resolving insurance claims.

For its equipment, Heavy Duty Rentals has equipped all of their large rental equipment with RSNs. In addition to assignment of RSNs to equipment for a particular rental company, RSNs can concurrently be assigned to multiple classes to match the organizational and/or functional assignments of the companies to whom the RSNs are assigned. For example, if there are multiple companies using RSNs at a construction site, each company can track their equipment individually by assigning a unique class to their RSN, yet each company can use the same network. Each RSN can also be assigned to multiple classes, and these assignments may be changed in the field at any time necessary.

Depending on rental company preference, all or some of the asset data collected by the RSN network can be shared and displayed amongst all companies, and/or shared with and stored at other locations, such as at corporate and district offices, service centers, and end-customer offices. Stored data can be used later for analysis and process improvement.

The RSN is mounted in a convenient location on the equipment. An RSN should not be completely enclosed by metal, but are preferably mounted in positions/locations that are physically protected and/or concealed from prying eyes. The RSNs are sufficiently robust to withstand the rigors and environments of active construction sites.

Each RSN has the ability to conduct self-diagnostics. If an RSN senses a fault, the network will notice and will notify Heavy Duty Rentals and Demo-Rite to this affect. If an RSN fails or is damaged, replacement RSNs can be easily installed and put into service and assigned appropriate Classes, on site or remotely. Heavy Duty Rentals has a small service team using local offices that can be dispatched to quickly and easily replace RSNs that fail.

As an RSN (and the equipment to which it is attached) moves into the coverage area established by a gateway at a site (i.e., within radio range of the gateway), the arrival and presence of that RSN (and of the asset to which the RSN is assigned) is automatically logged by the gateway as an Event Data Record (EDR), and that EDR is forwarded to and recorded at the asset management application running on the client server.

RSNs are RF-silent (no radio-frequency radiation) until a sensor input wakes them up, a command is received from a gateway, or another RSN requires a hop. Once data/commands have been sent, RSNs go silent again, until the next event. Consequently, RSNs consume very little power, rendering very long battery life and making it unnecessary for a person to have to remember to turn an RSN on or off. Indeed, because power consumption is so low, commercial RSNs have no on-off switch.

Additionally RSNs may be “pinged” (i.e., a gateway sends a “respond-if-you-are-there” command, and awaits a reply), or, using an RSN's onboard sensors, RSNs may be queried about their condition. Gateways may be programmed to ping or query at specific intervals (akin to regular roll-call) and report when a previously present RSN does not respond. Gateways anti/or RSNs may also be programmed to time intervals between RSN movement (using the onboard motion sensor) and issue an alarm if movement is detected outside the set interval.

RSNs may be used to monitor perimeter and gate/door security rather than monitor and track assets. RSNs attached to a perimeter fence can include sensors for detecting disturbances that may indicate someone climbing or breaching the fence. Similarly, the magnetic switch within RSNs could be used to detect open/close of gates, doors, tool cribs, etc.

RSNs may be used to monitor the presence of key personnel, such as a site manager or safety engineer. The key personnel could be assigned RSNs that would be worn on their belts, and their presence on the site could be monitored and confirmed using one or more preferred systems of the invention.

Heavy Duty Rentals can remotely query any of its RSNs. The collected data is then transferred directly into the RentalMate asset management application software. The location of gateway-equipped vehicles can also be displayed.

To enable a customer, such as Heavy Duty Rentals, to use the data generated by the network (and to manage the assets with the information), some form of asset management application software is required. The preferred system provided by Terahop Networks can interface with (talk to) asset management applications such as the RentalMate application, which Heavy Duty Rentals already uses and is familiar with. The Terahop network automates the collection of equipment presence data, run-time hours, and alarming events, and automatically inputs this data into the RunMate application.

Additionally, Demo-Rite can use a hand-held device (PDA), on which runs a simplified version of an asset management application. This PDA application allows Demo-Rite personnel to perform equipment management and diagnostics onsite without carrying a laptop or being confined to an office. All equipment records are kept up-to-date by downloading the data collected by the hand-held device to the main database when a user returns to the office.

In view of the foregoing, it will be understood that one or more preferred embodiments of the present invention provides a cost-effective, near-real-time solution for managing the location, usage, and security of construction equipment, both in storage and onsite. In particular, one or more preferred embodiments of the present invention enables and/or provides: a single infrastructure and overall system collectively for managing onsite assets, tracking engine run-time of onsite assets, guarding against onsite equipment theft, providing perimeter security; the ability to automatically access/receive timely and accurate data regarding the location and condition of onsite equipment; the ability to automatically receive near-real-time alerts when a piece of onsite equipment is disturbed or moved at times when there should be no disturbance or movement (e.g., after normal business hours); the ability to receive timely alerts that afford the opportunity to either interrupt an event or recover equipment before serious loss or damage; the ability to have an accurate, sequential, date/time-stamped record of onsite events, automatically collected and stored for record keeping and further analysis; the ability to have near-real-time engine run-time data to manage onsite asset usage, onsite labor hours, onsite equipment maintenance schedules, and onsite contract compliance; and the ability to have a seamless solution for managing assets using existing asset management software and back-office processes.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments in the rental construction equipment context, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof. Indeed, it is contemplated within the scope of the invention that the embodiments disclosed herein may equally be used in monitoring and tracking, for example, FEMA equipment and supplies.

What is claimed is:

1. A system in which construction equipment is tracked and monitored, comprising:
items of construction equipment, each item including a remote sensor node (RSN) associated therewith, each RSN including one or more class designations; and
a gateway controller, the gateway controller sharing at least one class designation in common with each RSN such that each RSN is able to communicate, directly or indirectly, with the gateway over a class-based network, the gateway controller configured to electronically communicate data from each RSNs for receipt by software running on a server that monitors and tracks the items of construction equipment associated with the RSNs from which the data is received.

2. The system of claim 1, further comprising a message management and routing system that facilitates communication between the gateway controller and the software running on the server.

3. The system of claim 2, wherein the message management and routing system is configured to handle requests for, and establish connections between, the gateway controller and the software running on the server.

4. The system of claim 1, wherein the gateway controller is fixedly located at a site at which the items of construction equipment are located.

5. The system of claim 1, wherein the gateway controller is configured to electronically communicate data from the RSNs over a wide area network (WAN).

6. The system of claim 5, wherein the gateway controller communicates data from the RSNs over a wired broadband connection.

7. The system of claim 1, wherein the gateway controller is mobile and is intermittently located at a site at which at least some of the items of construction equipment are located, other times being away from said site.

8. The system of claim 7, wherein the gateway controller is attached to a motor vehicle, and wherein the gateway controller communicates with the RSNs when driven within proximity of a site at which at least some of the items of construction equipment are located.

9. The system of claim 8, wherein the gateway controller communicates data from the RSNs over a cellular network.

10. The system of claim 8, wherein the gateway controller communicates data from the RSNs over a satellite network.

11. The system of claim 8, wherein the gateway controller communicates data from the RSNs over a WiMAX network.

12. The system of claim 8, wherein the gateway controller communicates data from the RSNs over a wireless broadband connection.

13. The system of claim 1, wherein each of the RSNs associated with the items of construction equipment are configured to send alerts indicative of theft of the items of construction.

14. The system of claim 1, wherein each of the RSN includes one or more sensors associated therewith.

15. The system of claim 1, wherein one of the sensors is meter that measures the time of operation of an item of construction equipment.

16. The system of claim 1, wherein the data communicated from one of the RSNs includes data regarding how long one of the items of the construction equipment associated with the particular one of the RSNs was operated.

17. The system of claim 1, wherein the data communicated from one of the RSNs includes runtime data pertaining to one of the items of the construction equipment associated with the particular one of the RSNs.

18. The system of claim 17, wherein the data comprises engine-hours data.

19. The system of claim 1, wherein at least one of the items of construction equipment is rented from a rental company.

20. The system of claim 1, wherein the items of construction equipment are rented from a rental company.

21. The system of claim 20, wherein the server running the software is owned by the rental company.

22. The system of claim 21, wherein the data communicated from one of the RSNs includes presence data pertaining to the continued presence of each of the items of the construction equipment associated with the particular RSNs, whereby the rental company determines whether any of the items of the rental equipment have been removed from one or more sites at which the items of construction equipment are located.

23. The system of claim 21, wherein the data communicated from one of the RSNs includes runtime data pertaining to one of the items of the construction equipment associated with the particular one of the RSNs, whereby the rental company determines whether contract limits on use of the rental equipment have been exceeded.

24. The system of claim 1, wherein at least one of the items of construction equipment is rented from a rental company, wherein the server running the software is owned by the rental company, and further comprising a plurality of additional RSNs configured to monitor for intrusions onto a site at which at least some of the items of construction equipment are located, the gateway controller sharing at least one class designation in common with each additional RSN such that each additional RSN is able to communicate, directly or indirectly, with the gateway over a different class-based network, the gateway controller configured to electronically communicate data sent from each of the additional RSNs for receipt by different software running on a different server that monitors the security of the site.

25. The system of claim 24, wherein the different software running on a different server that monitors the security of the site is owned by a security monitoring company and not by the rental company.

26. The system of claim 24, wherein none of the RSNs associated with the items of construction equipment that are rented from the rental company share a class in common with any of the additional RSNs, whereby distinct and separate radio networks are formed at the site.
